(19) United States
(12) Patent Application Publication
(10) Pub. No.: US 2024/0264354 A1
(43) Pub. Date: Aug. 8, 2024

(54) DUAL DIFFRACTION GRATING IN-COUPLER FOR REDUCED WAVEGUIDE THICKNESS BACKGROUND

(71) Applicant: INTERDIGITAL CE PATENT HOLDINGS, SAS, Paris (FR)

(72) Inventors: Oksana SHRAMKOVA, Liffré (FR); Valter DRAZIC, Betton (FR)

(21) Appl. No.: 18/566,472

(22) PCT Filed: Jun. 9, 2022
(86) PCT No.: PCT/EP2022/065617

§ 371 Date: Dec. 1, 2023

(30) Foreign Application Priority Data
Jun. 10, 2021 (EP) 21305794.6

(51) Int. Cl. F21V 8/00; G02B 27/01; G02B 27/42; G02B 27/00

(52) U.S. Cl. CPC G02B 6/0016; G02B 27/0172; G02B 27/4205; G02B 27/0081

(57) ABSTRACT

In example embodiments, an apparatus includes a waveguide having an in-coupler an out-coupler. The waveguide has a first surface and an opposite second surface, and the waveguide provides at least one optical path from the in-coupler to the out-coupler. The in-coupler comprises a first diffraction grating with a first grating vector on the first surface and a second diffraction grating with a second grating vector on the second surface. At least one of the first and second grating vectors is not oriented along any of the optical paths from the in-coupler to the out-coupler. The second grating may alter the polarization state of in-coupled light and/or change the direction of the in-coupled light to aid in preventing the light from being out-coupled by the first diffraction grating.

### CROSS-REFERENCE TO RELATED APPLICATION

This application claims priority of European Patent Application No. EP21305794, filed 10 Jun. 2021, which is incorporated herein by reference in its entirety.

### BACKGROUND

The present disclosure relates to the field of optics and photonics, and more specifically to planar optical devices. More particularly, but not exclusively, the present disclosure relates to diffraction gratings that can be used in a wide range of devices, such as, among other examples, displays, including in- and out-coupling of light in waveguides for eyewear electronic devices and head-mounted displays for AR (Augmented Reality) and VR (Virtual Reality) glasses, head up displays (HUD), as for example in the automotive industry, optical sensors for photo/video/lightfield cameras, bio/chemical sensors, including lab-on-chip sensors, microscopy, spectroscopy and metrology systems, and solar panels.

This section is intended to introduce the reader to various aspects of art, which may be related to various aspects of the present disclosure that are described and/or claimed below. This discussion is believed to be helpful in providing the reader with background information to facilitate a better understanding of the various aspects of the present invention. Accordingly, it should be understood that these statements are to be read in this light, and not as admissions of prior art.

AR/VR glasses are under consideration for a new generation of human-machine interface. Development of AR/VR glasses (and more generally eyewear electronic devices) is associated with a number of challenges, including reduction of size and weight of such devices as well as improvement of the image quality (in terms of contrast, field of view, color depth, etc.) that should be realistic enough to enable a truly immersive user experience.

The tradeoff between the image quality and physical size of the optical components motivates research into ultra-compact optical components that can be used as building blocks for more complex optical systems, such as AR/VR glasses. It is desirable for such optical components to be easy to fabricate and replicate. In such AR/VR glasses, various types of refractive and diffractive lenses and beam-forming components are used to guide the light from a micro-display or a projector towards the human eye, allowing forming a virtual image that is superimposed with an image of the physical world seen with a naked eye (in case of AR glasses) or captured by a camera (in case of VR glasses).

Some of kinds of AR/VR glasses utilize an optical waveguide wherein light propagates into the optical waveguide by TIR (for Total Internal Reflection) only over a limited range of internal angles. The FoV (for Field of View) of the waveguide depends on the material of the waveguide, among other factors.

### SUMMARY

References in the specification to “one embodiment,” “an embodiment,” “an example embodiment,” and the like indicate that the embodiment described may include a particular feature, structure, or characteristic; but not every embodiment necessarily includes that particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described.

An apparatus according to some embodiments includes a waveguide having an in-coupler and an out-coupler, the waveguide having a first surface and an opposite second surface, the waveguide providing at least one optical path from the in-coupler to the out-coupler. The in-coupler comprises a first diffraction grating with a first grating vector on the first surface and a second diffraction grating with a second grating vector on the second surface, and at least one of the first and second grating vectors is not oriented along any of the optical paths from the in-coupler to the out-coupler (for example, having an angle of more than 10° from the optical paths).

In some embodiments, the first diffraction grating is a transmissive grating and the second diffraction grating is a reflective grating.

In some embodiments, the first grating vector is substantially perpendicular to at least one of the optical paths, for example at an angle of between 80° and 100° from at least one of the optical paths.

In some embodiments, the second grating vector has an angle of 45° with respect to the first grating vector. In other embodiments, the second grating vector has an angle greater than 45° with respect to the first grating vector.

In some embodiments, the in-coupler is configured to couple incident light along at least one of the optical paths using a non-zero diffractive order of the first diffraction grating and a non-zero diffractive order of the second diffraction grating.

In some embodiments, the first grating vector is substantially parallel to at least one of the optical paths, for example having an angle of less than 10° with at least one of the optical paths.

In some embodiments, the second grating vector has an angle between 45° and 90° with respect to the first grating vector.

In some embodiments, the in-coupler is configured to couple incident light along at least one of the optical paths using a non-zero diffractive order of the first diffraction grating and the zeroth diffractive order of the second diffraction grating.

In some embodiments, the second diffraction grating has a grating period shorter than a wavelength of incident light in the waveguide.

In some embodiments, the second diffraction grating has a grating period less than 300 nm. In some embodiments, the second diffraction grating has a grating period less than 200 nm. In some embodiments, for a waveguide has a refractive index 1.7663 and is configured for use with incident light having a wavelength of 625 nm. In some embodiments, for a waveguide having refractive index n₃ configured to guide light of wavelength λ, the second diffraction grating has a grating period below λ/n₃.

In some embodiments, the second diffraction grating is metallized.

In some embodiments, each of the optical paths includes an eye pupil expander.

In some embodiments, at least one of the gratings comprises silicon grating elements.

A method according to some embodiments includes directing incident light on an in-coupler of a waveguide, the in-coupler comprising a first diffraction grating with a first grating vector on a first surface of the waveguide and a second diffraction grating with a second grating vector on an opposite second surface of the waveguide, the waveguide providing at least one optical path from the in-coupler to an out-coupler of the waveguide, wherein at least one of the first and second grating vectors is not oriented along any of the optical paths from the in-coupler to the out-coupler (for example, having an angle of more than 10° from the optical paths); diffracting the incident light to a non-zero diffractive order with the first diffraction grating; and reflecting the diffracted light with the second diffraction grating.

In some embodiments, the reflecting further includes modifying a polarization state of the diffracted light with the second diffraction grating.

In some embodiments, the reflecting further includes reflecting at least one diffractive order of the diffracted light to a direction substantially orthogonal to the first grating vector, for example at an angle of between 80° and 100° from at least one of the optical paths.

An apparatus according to some embodiments includes a waveguide having an in-coupler and an out-coupler, the waveguide having a first surface and an opposite second surface, the waveguide providing at least one optical path from the in-coupler to the out-coupler. The in-coupler comprises a first diffraction grating with a first grating vector on the first surface and a second diffraction grating with a second grating vector on the second surface, the second diffraction grating having a grating period less than 300 nm.

In some embodiments, the second grating vector has an angle of at least 35° with respect to the first grating vector.

A method according to some embodiments includes directing incident light on an in-coupler of a waveguide, the in-coupler comprising a first diffraction grating with a first grating vector on a first surface of the waveguide and a second diffraction grating with a second grating vector on an opposite second surface of the waveguide, the waveguide providing at least one optical path from the in-coupler to an out-coupler of the waveguide, wherein at least one of the first and second grating vectors is not oriented along any of the optical paths from the in-coupler to the out-coupler. The incident light is directed to a non-zero diffractive order with the first diffraction grating, and the diffracted light is reflected with the second diffraction grating.

In some embodiments, the in-coupler is configured to couple incident light along at least one of the optical paths using a non-zero diffractive order of the first diffraction grating and a non-zero diffractive order of the second diffraction grating.

In some embodiments, the in-coupler is configured to couple incident light along at least one of the optical paths using a non-zero diffractive order of the first diffraction grating and the zeroth diffractive order of the second diffraction grating.

In some embodiments, the second diffraction grating has a grating period shorter than a wavelength of the incident light in the waveguide.

An apparatus according to some embodiments comprises an image generator configured to generate incident light representing an image; a waveguide having a first surface and an opposite second surface; a transmissive diffraction grating on the first surface configured to diffract the incident light into the waveguide; and a reflective diffraction grating on the second surface configured to rotate the polarization of the incident light.

In some embodiments, the reflective diffraction grating has a grating period shorter than a wavelength of the incident light in the waveguide.

In some embodiments, the waveguide includes an out-coupler, and the transmissive diffraction grating and the reflective diffraction grating are configured to couple the incident light along an optical path to the out-coupler using a non-zero diffractive order of the first diffraction grating and the zeroth diffractive order of the second diffraction grating.

In some embodiments, the waveguide includes an out-coupler, and the transmissive diffraction grating and the reflective diffraction grating are configured to couple the incident light along an optical path to the out-coupler using a non-zero diffractive order of the first diffraction grating and a non-zero diffractive order of the second diffraction grating.

### BRIEF DESCRIPTION OF THE DRAWINGS

FIG. 1A is a cross-sectional schematic view of a waveguide display.

FIG. 1B is a schematic illustration of a binocular waveguide display with a first layout of diffractive optical components.

FIG. 1C is a schematic illustration of a binocular waveguide display with a second layout of diffractive optical components.

FIG. 1D is a schematic exploded view of a double-waveguide display according to some embodiments.

FIG. 1E is a cross-sectional schematic view of a double-waveguide display according to some embodiments.

FIG. 1F schematically illustrates a diffraction grating (DG) with symmetrical grooves that tiles angularly the exit pupil of a light engine.

FIGS. 2A-2C are schematic side views illustrating coupling of a range of incident light into a waveguide.

FIGS. 3A-3B are schematic side views of an in-coupler illustrating reflection of a ray coupled at the critical angle.

FIGS. 4A and 4B illustrate a double-sided grating coupler for light guides as described in S. Siitonen et al.

FIG. 5 is a schematic perspective view of a double-sided in-coupler according to some embodiments.

FIG. 6A is a cross-sectional view of a unit cell of high refractive index material regular in-coupling diffraction grating DG1.

FIG. 6B illustrates reflectance and transmittance of a TE polarized incident wave for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm vs. angle of electromagnetic wave incidence (α) at λ=625 nm for incidence from host medium with refractive index n₁.

FIGS. 7A-7B illustrate reflectance and transmittance of a TE polarized incident wave for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm at λ=625 nm vs. angle of electromagnetic wave incidence (α) for incidence from waveguide material with refractive index n₃. FIG. 7A illustrates results for azimuth angle φᵢ=−π/2. FIG. 7B illustrates results for azimuth angle φᵢ=0.

FIG. 8A illustrates a cross-sectional view of a unit cell of high refractive index material reflective diffraction grating DG2. FIG. 8B illustrates reflectance and transmittance of reflective diffraction grating DG2 with d₂=338.38 nm, W*=50 nm, H*=150 nm, H₁=20 nm, n₁=1.0, n₂*=3.897+i0.021061, n₃=1.7663, n₄=1.457, ϕ_{G2}=π/4 vs. angle of TE polarized electromagnetic wave incidence (α) at λ=625 nm for incidence from waveguide material with refractive index n₃ and φ_{d}=π/2.

FIGS. 9A-9B illustrate reflectance and transmittance of a TM polarized incident wave for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm at λ=625 nm vs. angle of electromagnetic wave incidence (α) for incidence from waveguide material with refractive index n₃. FIG. 9A illustrates results for azimuth angle φᵢ=−π/2. FIG. 9B illustrates results for azimuth angle φᵢ=0.

FIG. 10 illustrates reflectance and transmittance of reflective diffraction grating DG2 with d₂=338.38 nm, W*=50 nm, H*=150 nm, H₁=20 nm, n₁=1.0, n₂*=3.897+i0.021061, n₃=1.7663, n₄=1.457, ϕ_{G2}=π/4 vs. angle of TM polarized electromagnetic wave incidence (α) at λ=625 nm for incidence from waveguide material with refractive index n₃ and φ_{d}=π/2.

FIGS. 11A-11B illustrate reflectance and transmittance of reflective diffraction grating DG2 with d₂=338.38 nm, W*=66 nm, H*=170 nm, H₁=50 nm, n₁=1.0, n₂*=3.897+i0.021061, n₃=1.7663, n₄=1.457, ϕ_{G2}=π/4 vs. angle of TE (FIG. 11A) and TM (FIG. 11B) polarized electromagnetic wave incidence (α) at λ=625 nm for incidence from waveguide material with refractive index n₃ and φ_{d}=π/2.

FIG. 12 is a schematic perspective view of a waveguide display according to some embodiments.

FIG. 13 is a schematic side view of a waveguide according to some embodiments illustrating in-coupled light.

FIG. 14A is a cross-sectional view of a unit cell of high refractive index material regular in-coupling diffraction grating DG1.

FIG. 14B is a graph illustrating reflectance and transmittance of a TE polarized incident wave for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm vs. angle of electromagnetic wave incidence (α) at λ=625 nm for incidence from host medium with refractive index n₁.

FIGS. 15A-15B illustrate reflectance and transmittance of TE (FIG. 15A) and TM (FIG. 15B) polarized incident waves for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm at λ=625 nm vs. angle of electromagnetic wave incidence (α) for incidence from waveguide material with refractive index n₃.

FIG. 16A is a cross-sectional view of a unit cell of high refractive index material reflective diffraction grating DG2.

FIG. 16B is a graph illustrating reflectance and transmittance of reflective diffraction grating DG2 with d₂=150 nm, W*=80 nm, H*=140 nm, H=80 nm, n₁=1.0, n₂*=3.897+i0.021061, n₃=1.7663, n₄=n₅=1.457, φ_{G2}=45° vs. angle of TE polarized electromagnetic wave incidence (α) at λ=625 nm for incidence from waveguide material with refractive index n₃. The surface between materials with refractive indexes n₁ and n₅ was metallized.

FIG. 17 is a graph illustrating reflectance and transmittance of reflective diffraction grating DG2 with d₂=150 nm, W*=35 nm, H*=185 nm, H₁=5 nm, n₁=n₅=1.0, n₂*=3.897+i0.021061, n₃=1.7663, n_{4=1.457}, φ_{G2}=45° vs. angle of TE polarized electromagnetic wave incidence (α) at λ=625 nm for incidence from waveguide material with refractive index n₃. The surface between materials with refractive indexes n₁ and n₅ was metallized.

FIG. 18 is a graph illustrating reflectance and transmittance of nonmetallized reflective diffraction grating DG2 with d₂=130 nm, W*=40 nm, H*=270 nm, H=180 nm, n₁=1.0, n₂*=3.897+i0.021061, n₃=1.7663, n₄=n₅=1.457, φ_{G2}=60° vs. angle of TE polarized electromagnetic wave incidence (α) at λ=625 nm for incidence from waveguide material with refractive index n₃.

FIG. 19 illustrates reflectance and transmittance of nonmetallized reflective diffraction grating DG2 with d₂=130 nm, W*=40 nm, H*=250 nm, H=140 nm, n₁=1.0, n₂*=3.897+i0.021061, n₃=1.7663, n₄=n₅=1.457, φ_{G2}=75° vs. angle of TE polarized electromagnetic wave incidence (α) at λ=625 nm for incidence from waveguide material with refractive index n₃.

FIG. 20 is a schematic perspective view of a waveguide display according to some embodiments.

FIG. 21 is a schematic perspective view of a waveguide display according to some embodiments.

### DETAILED DESCRIPTION

The present disclosure relates to the field of optics and photonics, and more specifically to optical devices comprising at least one diffraction grating. Diffraction gratings as described herein may be employed in the field of conformable and wearable optics, such as AR/VR glasses, as well as in a variety of other electronic consumer products comprising displays and/or lightweight imaging systems. Example devices for application may include head-mounted displays (HMD) and lightfield capture devices. Such diffraction grating modulating the unpolarized light may find application in solar cells.

Example optical devices are described that include one or more over-wavelength diffraction gratings that can be used for in-coupling light into the optical device and/or out coupling light from the optical device. Such optical devices can be used as a waveguide for AR/VR glasses for instance.

In example embodiments, over-wavelength in-coupling gratings can be used to generate intensive high diffraction orders for different polarizations (TE and TM) simultaneously. In contrast to some single-material systems that may provide intensive response only for one polarization (TE or TM, depending on the size of the elements), embodiments with two or more materials as described herein, including some embodiments that use a high refractive index material, may provide a strong response for both polarizations. However, embodiments described herein are not limited to multi-material gratings.

Some embodiments aim to provide high performance in terms of brightness for in-coupling light into an optical device.

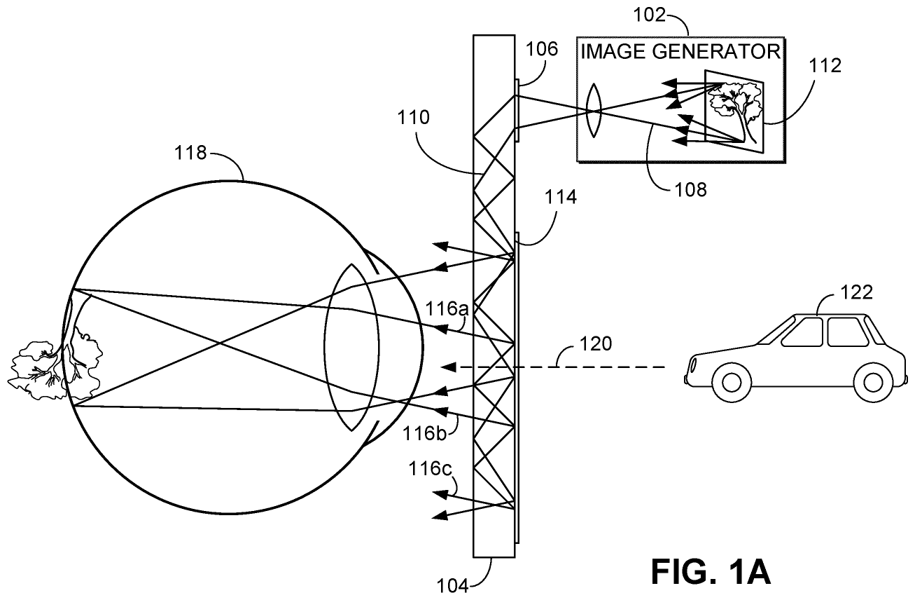

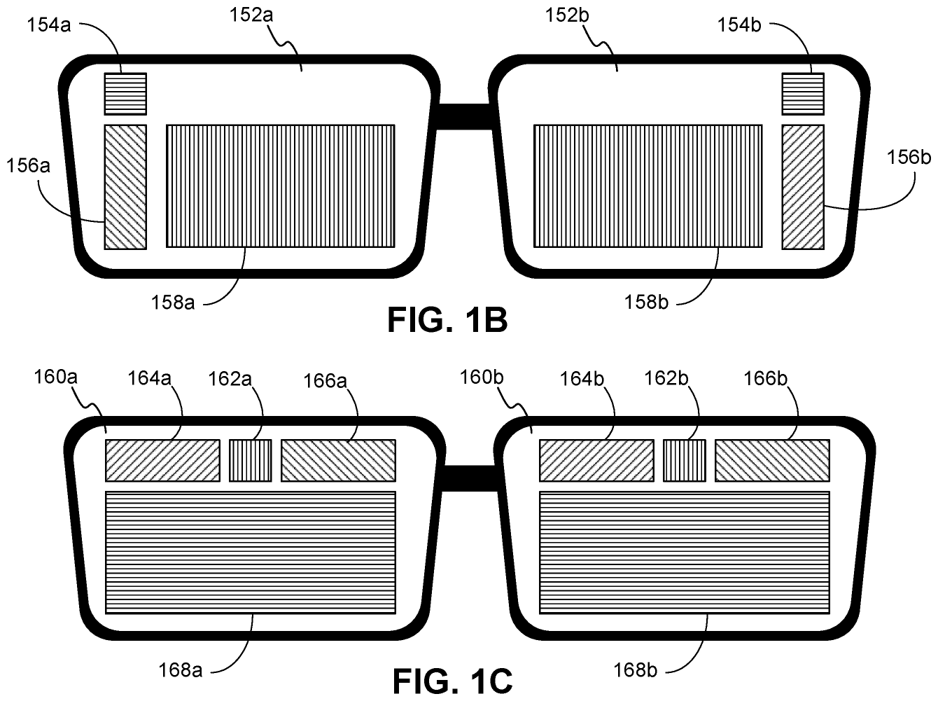

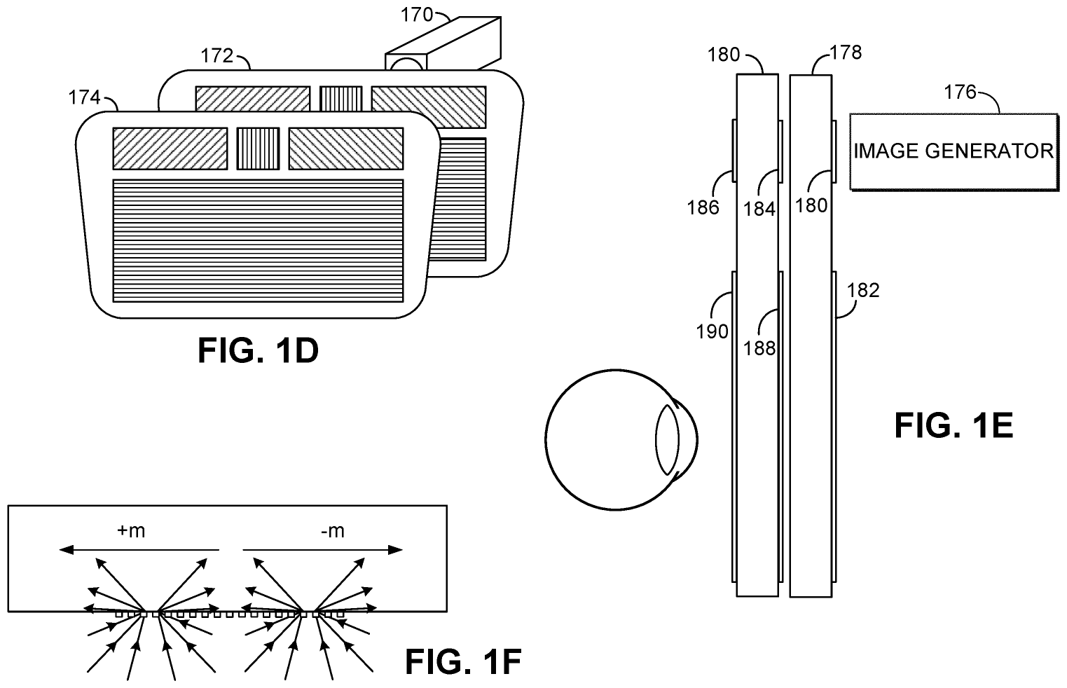

An example waveguide display device that may employ diffraction grating structures as described herein is illustrated in FIG. 1A. FIG. 1A is a schematic cross-sectional side view of a waveguide display device in operation. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (pLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

In some embodiments, as described in further detail below, a waveguide display includes more than one waveguide layer. Each waveguide layer may be configured to preferentially convey light with a particular range of wavelengths and/or incident angles from the image generator to the viewer.

As illustrated in FIGS. 1B and 1C, waveguide displays having in-couplers, out-couplers, and pupil expanders may have various different configurations. An example layout of one binocular waveguide display is illustrated in FIG. 1B. In the example of FIG. 1B, the display includes waveguides 152a, 152b for the left and right eyes, respectively. The waveguides include in-couplers 154a,b, pupil expanders 156a,b, and components 158a,b, which operate as both out-couplers and horizontal pupil expanders. The pupil expanders 156a,b are arranged along an optical path between the in-coupler and the out-coupler. An image generator (not shown) may be provided for each eye and arranged to project light representing an image on the respective in-coupler.

An example layout of another binocular waveguide display is illustrated in FIG. 1C. In the example of FIG. 1C, the display includes waveguides 160a, 160b for the left and right eyes, respectively. The waveguides include in-couplers 162a,b. Light from different portions of an image may be coupled by the in-couplers 162a,b to different directions within the waveguides. In-coupled light traveling toward the left passes through pupil expanders 164a,b, while in-coupled light traveling toward the right passes through pupil expanders 166a,b. Having passed through the pupil expanders, light is coupled out of the waveguides using components 168a,b, which operate as both out-couplers and vertical pupil expanders to substantially replicate an image provided at the in-couplers 162a,b.

The waveguide display of FIG. 1B may be referred to as a single-mode waveguide display, as a single diffractive order (e.g. +M) diffracted by the in-coupler (154a or 154b) follows an optical path through the pupil expander (156a or 156b) to the out-coupler (158a or 158b). The waveguide display of FIG. 1C may be referred to as a dual-mode waveguide display, as two diffractive orders (e.g. both+M and −M) diffracted by the in-coupler (162a or 162b) follow respective optical paths through the pupil expanders to the out-coupler (168a or 168b).

In different embodiments, different features of the waveguide displays may be provided on different surfaces of the waveguides. For example (as in the configuration of FIG. 1A), the in-coupler and the out-coupler may both be arranged on the anterior surface of the waveguide (away from the user's eye). In other embodiments, the in-coupler and/or the out-coupler may be on a posterior surface of the waveguide (toward the user's eye). The in-coupler and out-coupler may be on opposite surfaces of the waveguide. In some embodiments, one or more of an in-coupler, an out-coupler, and a pupil expander, may be present on both surfaces of the waveguide. The image generator may be arranged toward the anterior surface or toward the posterior surface of the waveguide. The in-coupler is not necessarily on the same side of the waveguide as the image generator. Any pupil expanders in a waveguide may be arranged on the anterior surface, on the posterior surface, or on both surfaces of the waveguide. In displays with more than one waveguide layer, different layers may have different configurations of in-coupler, out-coupler, and pupil expander.

FIG. 1D is a schematic exploded view of a double waveguide display according to some embodiments, including an image generator 170, a first waveguide (WG1) 172, and a second waveguide (WG2) 174. FIG. 1E is a schematic side-view of a double waveguide display according to some embodiments, including an image generator 176, a first waveguide (WG1) 178, and a second waveguide (WG2) 180. The first waveguide includes a first transmissive diffractive in-coupler (DG1) 180 and a first diffractive out-coupler (DG6) 182. The second waveguide has a second transmissive diffractive in-coupler (DG2) 184, a reflective diffractive in-coupler (DG3) 186, a second diffractive out-coupler (DG4) 188, and a third diffractive out-coupler (DG5) 190. Different embodiments may use different arrangements of optical components (such as different arrangements of pupil expanders) on the first and second waveguides.

While FIGS. 1A-1E illustrate the use of waveguides in a near-eye display, the same principles may be used in other display technologies, such as head up displays for automotive or other uses.

### The Relationship Between In-Coupler Configuration and Waveguide Thickness.

The introduction of a new in-coupling system for coupling an incident light into a thin waveguide is of a certain practical interest. Such an optical device can be used as a waveguide for AR/VR glasses for instance. However, there are challenges that arise from the use of a thin waveguide. If the in-coupling grating has relatively large dimensions compared to the thickness of the waveguide, then there is a risk that light will exit the waveguide through the very same grating that was meant to in-couple the light. That is, the grating couples the light into the waveguide, and the light is reflected from the opposite surface of the waveguide by total internal reflection, but if the light has not traveled far enough laterally (because of a wide grating and/or a thin grating), the light will strike the same grating again, and much of that light will exit the waveguide. As a result, the efficiency of the in-coupled light will be dramatically reduced. Example embodiments address this issue by providing in-coupled wave deflection in the orthogonal direction inside the waveguide and polarization transformation leading to the effective reflection of the deflected light by the in-coupling grating.

The optical see-through head mounted display (HMD) is useful for augmented/virtual reality (AR/VR) applications. To realize a compact near-eye display system for AR with a wide field of view, various technologies have been developed. Currently many of the AR-based HMDs use a waveguide structure in order to reduce the overall size and weight of the device. The waveguide structure generally includes in- and out-couplers comprising surface relief gratings or holographic volume gratings. To couple light into the waveguide and provide good color uniformity, it is desirable for diffracted non-zero order light to have high intensity across a wide angular range.

The field of view in systems based on optical waveguides is limited by the angular bandwidth of the glass plate. If we diffract one mode into the glass plate, the FoV is given as a function of the index of refraction of the material of the glass plate. The FoV of a waveguide of refractive index n₃ is given by:

$$Δ {θ}_{1} = 2 {sin}^{- 1} ( \frac{{n}_{3} - 1}{2} ) .$$

The field of view of an optical waveguide can be further extended by taking advantage of a second direction of propagation inside of the waveguide, doubling it.

FIG. 1F schematically illustrates a diffraction grating (DG) with symmetrical grooves that tiles angularly the exit pupil of a light engine. One part of the pupil is diffracted into the +m^{th} diffraction order, and the symmetrical part of the pupil in the −m^{th} diffraction order. The field of view of a waveguide may be described by reference to the maximum span of θ₁⁺-θ₁⁻ which propagates into the waveguide by total internal reflection.

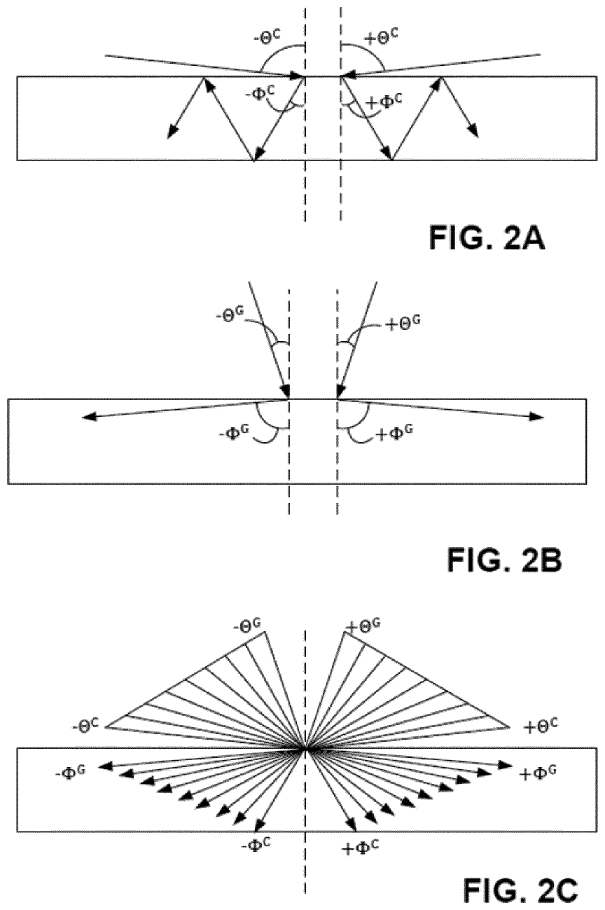

As illustrated by FIGS. 2A-2C, the largest angular span that can be coupled into the waveguide may be represented by two rays: the critical ray (θ^{C} in FIGS. 2A-2C) having incident angle θ^{C} and the grazing ray (BG in FIGS. 2A-2C) having incident angle θG. The critical ray is the light ray that just diffracts into the waveguide at the critical angle Φ^{C} expressed by

$$sin {Φ}^{C} = \frac{1}{{n}_{3} ( λ )}$$

where n₃ is the refractive index of the waveguide's material at wavelength λ, where λ the wavelength of the incident light. Above the critical angle Φ^{C}, total internal reflection (TIR) occurs, as illustrated in FIG. 2A. The grazing ray is the ray having an input angle θ^{G} that diffracts into the waveguide at grazing incidence Φ^{G} that approaches 90°, as illustrated in FIG. 2C. In some cases, the grazing ray has an input angle θ^{G} at or near 0°, although θ^{G} is illustrated with a larger angle in FIG. 2C for the sake of legibility. The theoretical FoV of a waveguide presented above is for a single mode system where one single diffraction mode is used to carry the image: either +1 or −1 diffraction mode.

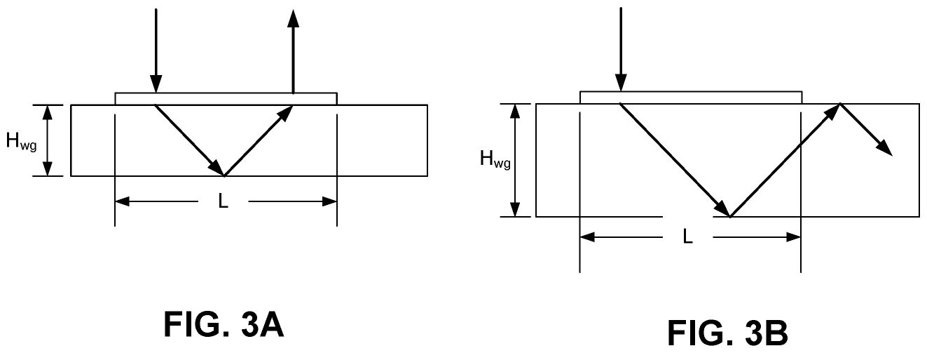

To determine the thickness of the waveguide for some particular size of the in-coupling diffraction grating, taking into account the size of the exit pupil of the light engine, it is desirable to avoid or diminish the possibility of out-coupling the light reflected from the backside of the waveguide by this diffraction grating (see FIG. 3A). As a result, to avoid the intersection/interaction of the light reflected from the backside of the waveguide with the in-coupling diffraction grating and prevent the consequent out-coupling of the light, it is desirable for the thickness H_{wg} of the waveguide to be bigger than

$${H}_{w g} = \frac{L}{2 tan {θ}_{min}} \qquad ( 1 )$$

where L is the size (length in the direction perpendicular to the grating lines) of the in-coupling grating and θₘᵢₙ is the minimal diffracted angle inside the waveguide (see FIG. 3B). To provide a good angular bandwidth in the waveguide, it is desirable for θₘᵢₙ=θ_{TIR}=Φ^{C}, where θ_{TIR} is an angle of total internal reflection. For example, to cover possible FoV for L=5 mm, it is desirable for the total thickness of the waveguide with refractive index 1.766 to be bigger than 3.64 mm.

This thickness is not desirable for use with practical glass form devices. It would make the system bulky and heavy. Moreover, there is a second problem: the successive bounces inside of the waveguide will be spatially separated. For instance, on FIG. 3, the first bounce will hit the top surface at position L, which is 5 mm away from the first in-coupling. As the pupil of the eye is smaller than 5 mm, only one bounce wan be visible at a time at the out-coupling. For other incident angles it is even worse, because we will be above the TIR angle which is the smallest propagating angle in the waveguide, and the successive bounces will be more and more apart. The system may suffer from a loss of resolution.

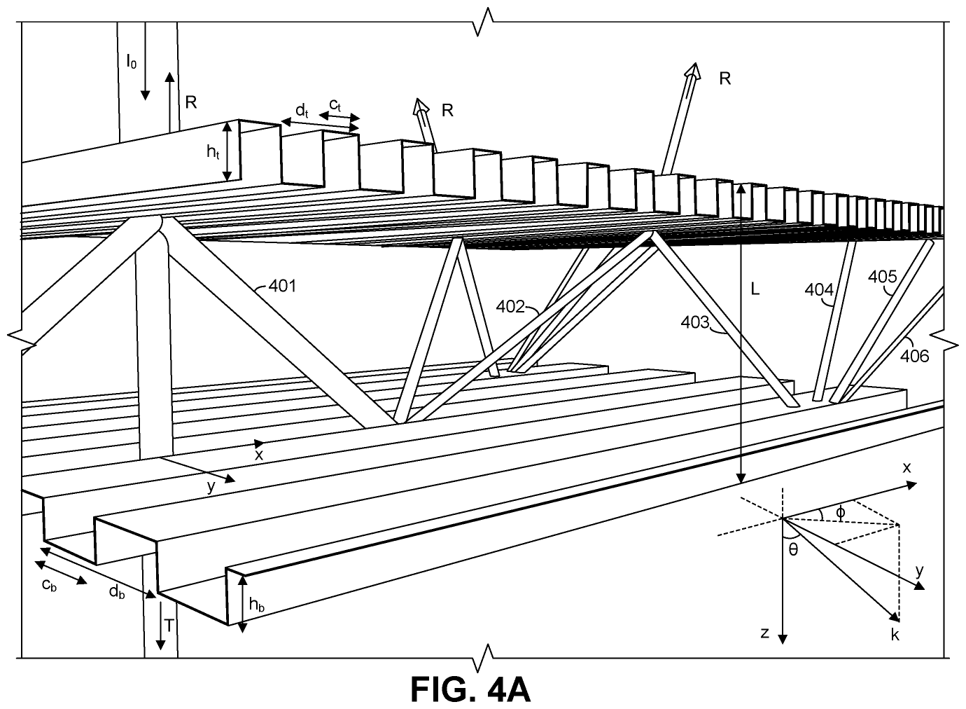

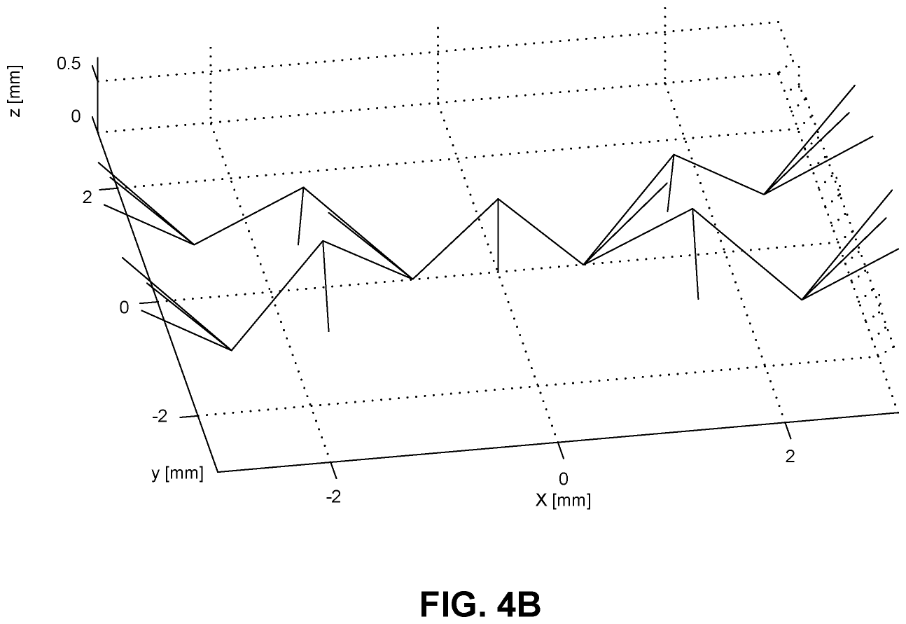

As it was demonstrated before in S. Siitonen, P. Laakkonen, J. Tervo, and M. Kuittinen, “A double-sided grating coupler for thin light guides,” Opt. Expr., vol. 15, pp. 2008-2018, 2008, to increase the in-coupling efficiency, double-sided diffraction gratings can be used (see FIG. 4A). In FIG. 4A, L is the thickness of the waveguide, d is the grating period, h is the height of the grating and the filling factor of the grating f=c/d. The subscripts t and b denote the gratings at top and bottom surfaces, respectively. In the proposed case the gratings are perpendicularly oriented to deflect the ray propagation angle inside the waveguide (see FIG. 4B). The parameters of the bottom reflective grating were optimized to maximize the diffraction efficiency of the first reflection orders.

In the system of Siitonen et al., the incoupled ray 401 hits the lower grating in a conical mounting and therefore it is totally reflected and simultaneously split into two rays by the grating. When the ray 402 hits the upper grating, a part of it is coupled out and the remaining part is split between the reflected diffraction orders. Since the ray 402 reaches the upper grating in a direction other than the diffraction orders of the grating, the grating does not couple it efficiently out. Most of the further reflected rays, like rays 403-406, are also coupled out inefficiently because they do not reach the top grating in the directions of diffraction orders. Finally, the rays leave the grating region and will propagate inside the light guide purely by total internal reflections.

The system of Siitonen et al. provides one technique for trapping more light inside a thin waveguide. However, this system was designed primarily for applications such as backlights and is not ideal for waveguide displays. One drawback of this system is the splitting of the in-coupled light between multiple diffraction orders and the change of the propagation angle of light inside of the waveguide. This fact can complicate the utilization of this solution for AR applications taking into account the combination of the in-coupler with the building blocks of the whole system (Eye Pupil Expander (EPE) and out-coupler).

### Embodiments Using Non-Zero-Order Diffraction by the Second Grating.

Some embodiments disclosed herein employ a double diffraction grating in-coupler for 90° rotation of in-coupled light leading to the effective light trapping by the thin waveguide.

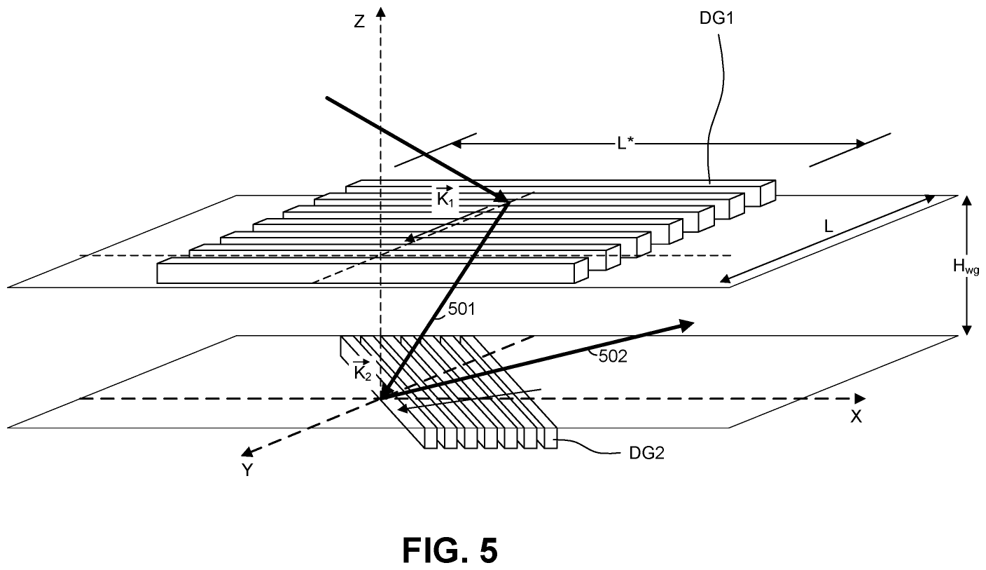

The double-sided in-coupler geometry with differently oriented gratings DG1 and DG2 on both waveguide surfaces is shown in FIG. 5. H_{wg} is the thickness of the waveguide. The incident light is diffracted by the first transmissive diffraction grating DG1 with grating lines oriented along the waveguide and in-coupling it into the waveguide. The diffraction grating has the lines which are perpendicular to the vector K₁ direction, θ, is an incident polar angle, θ_{d} is diffracted polar angle for order M>0; φᵢ and φ_{d} are incident and diffracted azimuth angles; n₁ is the refractive index of the medium outside the waveguide, n₃ is the refractive index of the waveguide material. Consider one particular plane of incidence. The double mode solution is described by the conical diffraction equations assuming that φᵢ=π/2 (along the YZ plane in FIG. 5). For example, consider the in-coupled rays propagating along the plane YZ. The in-coupled ray 501 hits the lower grating DG2 which has a different orientation with respect to the grating vector K₂. The angle of the lower grating orientation is equal to ϕ_{G2}, correspondingly for the grating vector oriented perpendicularly to the grating lines we get ϕₖ₂=π−ϕ_{G2}. For an example lower diffraction grating according to some embodiments, the incident ray 501 will be split into two rays. The first ray corresponding to the 0 reflected order ray will propagate in the same plane YZ, the second one corresponding to the first reflected order will be rotated and finally will propagate in the perpendicular plane XZ. The reoriented ray 502 will be totally reflected by the upper grating. Finally, the ray 502 leaves the grating area and propagates inside the waveguide by total internal reflection (TIR).

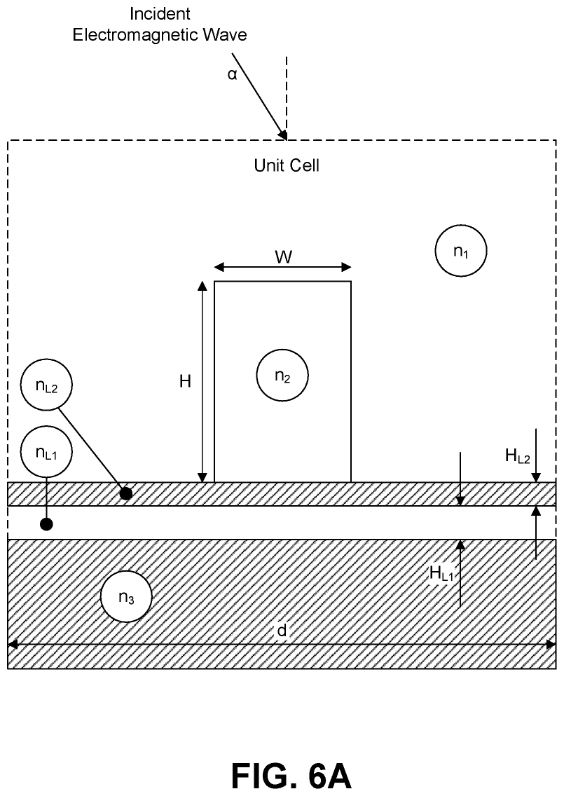

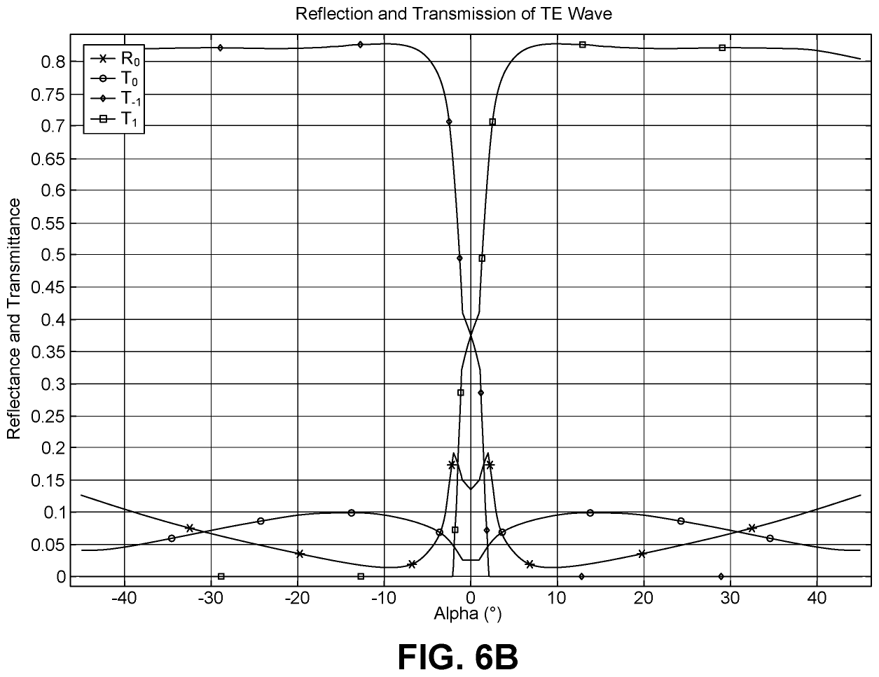

The performance of such a system has been simulated with an example grating configuration as follows. The example grating configuration uses a regular high refractive index material diffraction grating DG1 with an additional thin layer (H_{L1} is the thickness of this layer with refractive index n_{L1}) placed on the top of the waveguide. The general topology of the unit cell of regular symmetrical transmissive diffraction grating is illustrated in FIG. 6A. This cross-section view may correspond to high refractive index (n₂) element on the top of a homogeneous dielectric media with a refractive index n₃ (n₂>n₃). The full system is hosted by the homogeneous host medium with refractive index n₁. It is assumed that n₁<n₃. Wand H are width and height of the high refractive index element. The diffraction grating is a periodic array of the unit cells. The grating constant or the period of the grating is d=d₁. The period of the diffraction grating is selected to in-couple diffraction order M₁. To calculate the grating pitch, it can be assumed that the biggest angular span that can be coupled propagates into the waveguide by TIR. A linearly polarized TE plane wave is incident on the grating from the top in a plane perpendicular to the grating. To simplify the fabrication process, some embodiments include a stop layer between this thin layer and elements of the grating. The refractive index of the stop layer material is n_{L2}, and H_{L2} is the thickness of this layer. Example embodiments use silicon (Si) as the material of the elements of at least one of the gratings (n₂=3.897+i0.021061). The presented data were obtained using the COMSOL Multiphysics software.

FIG. 6A is a cross-sectional view of a unit cell of high refractive index material regular in-coupling diffraction grating DG1. FIG. 6B illustrates reflectance and transmittance of a TE polarized incident wave for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm vs. angle of electromagnetic wave incidence (α) at λ=625 nm for incidence from host medium with refractive index n₁.

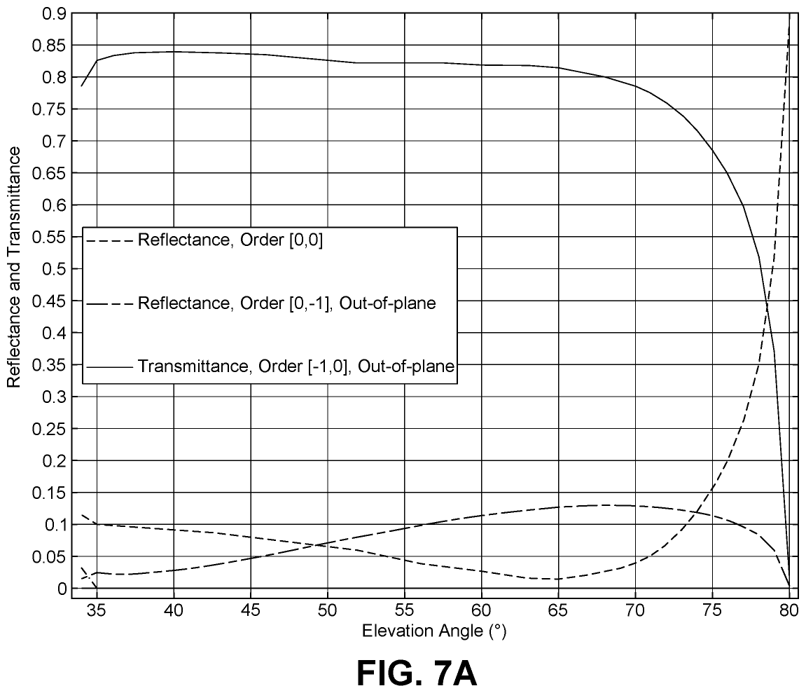

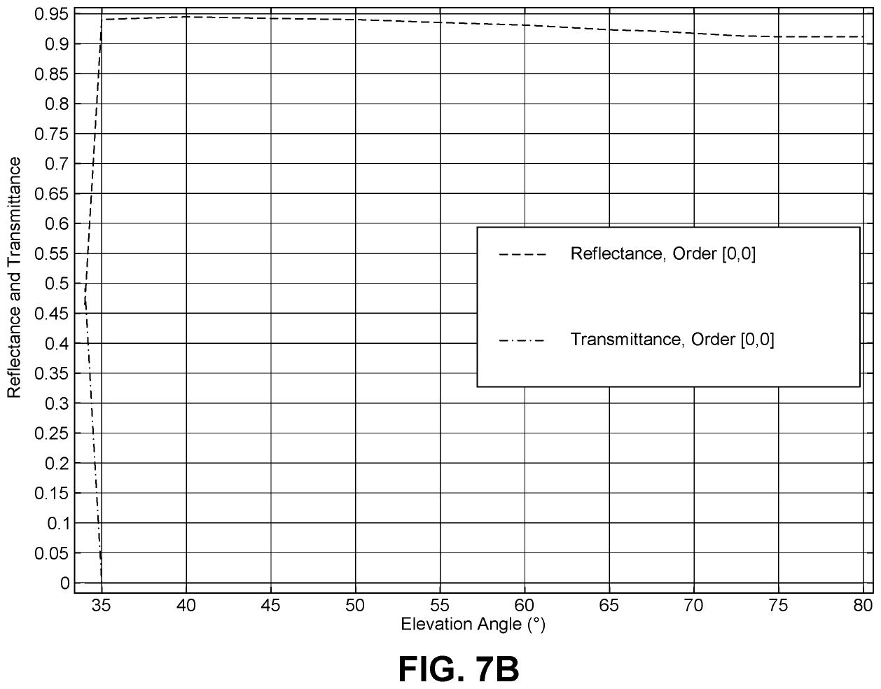

FIG. 6B illustrates the computed reflectance and transmittance for TE incidence for such regular grating oriented along the waveguide (ϕ_{G1}=0°, ϕ_{K1}=−π/2) for azimuth angle φᵢ=−π/2 vs. polar incident angle α. It illustrates the reflectance for 0-order and transmittance for 0 and ±1 orders. It can be seen that such high refractive index material diffraction grating has very high intensity for transmitted first order with maximal intensity equal to hₘₐₓ=82.76%. The diffraction uniformity is equal to 94.83%. The diffraction power of such grating is equal to 81.75%. But in the case of a thin waveguide, the in-coupled light is reflected back from the backside of the waveguide onto the grating area. It will hit the in-coupling grating DG1 and, much of the light will be outcoupled. To demonstrate this we can analyze the computed reflectance and transmittance for TE incidence from the waveguide material with refractive index n₃ (see the curve “Transmittance, order [−1,0], out-of plane” in FIG. 7A).

FIGS. 7A-7B illustrate reflectance and transmittance of TE polarized incident wave for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm at λ=625 nm vs. angle of electromagnetic wave incidence (α) for incidence from waveguide material with refractive index n₃. FIG. 7A illustrates results for azimuth angle φᵢ=−π/2. FIG. 7B illustrates results for azimuth angle φᵢ=0.

For comparison, also presented is the computed reflectance and transmittance for TE incidence from the waveguide material with refractive index n₃ for azimuth angle φᵢ=0 (FIG. 7B). The simulation shows that the orthogonal TE-polarized incident wave will be almost totally reflected by the grating DG1. So, the rotation of the ray 501 can help prevent out-coupling of the light after interaction with the grating DG1.

To rotate the ray 501 and get ray 502 propagating in the orthogonal plane, example embodiments use second lower grating DG2 with grating orientation angle equal to ϕ_{G2}. In example embodiments, ϕ_{G2}=π/4. To select a pitch of DG2 the grating equations will be written as

$${n}_{2} sin {θ}_{e} cos {φ}_{e} + {n}_{2} sin {θ}_{d} cos {φ}_{d} = \frac{{M}_{2} λ}{{d}_{2}} cos {ϕ}_{K 2} \qquad ( 2 )$$

$${n}_{2} sin {θ}_{e} sin {φ}_{e} + {n}_{2} sin {θ}_{d} sin {φ}_{d} = \frac{{M}_{2} λ}{{d}_{2}} sin {ϕ}_{K 2}$$

Here θ_{d} and φ_{d} are polar and azimuth angles diffracted by the first grating DG1, θₑ and φₑ are polar and azimuth angles diffracted by the second grating DG2, M₂ is the diffraction order. To select the pitch of the deviating grating, an interval may be considered for the diffracted polar angle θₑ using the minimal and maximal pitch sizes for the corresponding angular ranges for the in-coupled incident rays and rays diffracted by the deviation grating DG2. A solution may be selected to satisfy the condition for which the maximal value of the minimal pitch and the minimal value of the maximal pitch for the range of diffracted angles will be equal. Assuming that ϕ_{G2}=π/4 the following formula for may be used for determination of the period of DG2:

$${d}_{2} = {M}_{2} λ sin ( {ϕ}_{K 2} - Δ Φ ) , sin ( 2 Δ Φ ) = sin ( 2 {ϕ}_{K 2} ) - \frac{1}{{n}_{2} sin {θ}_{d}^{G}} , \qquad ( 3 )$$

where θ_{d}^{G} is the grazing angle.

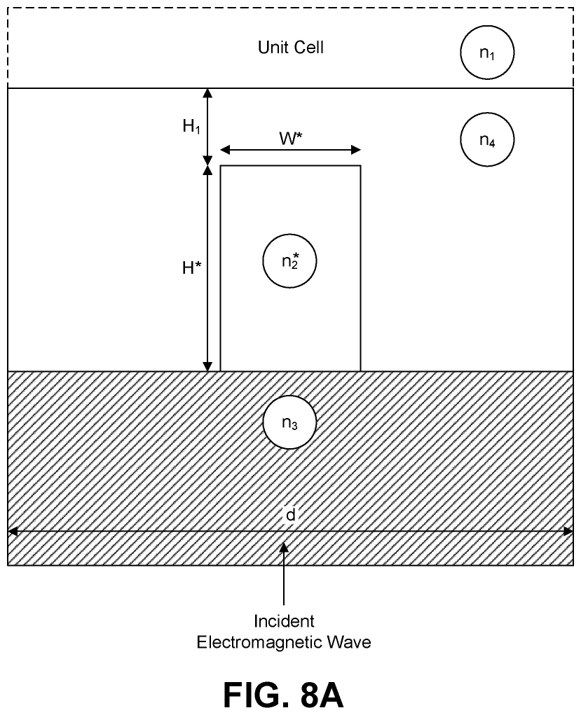

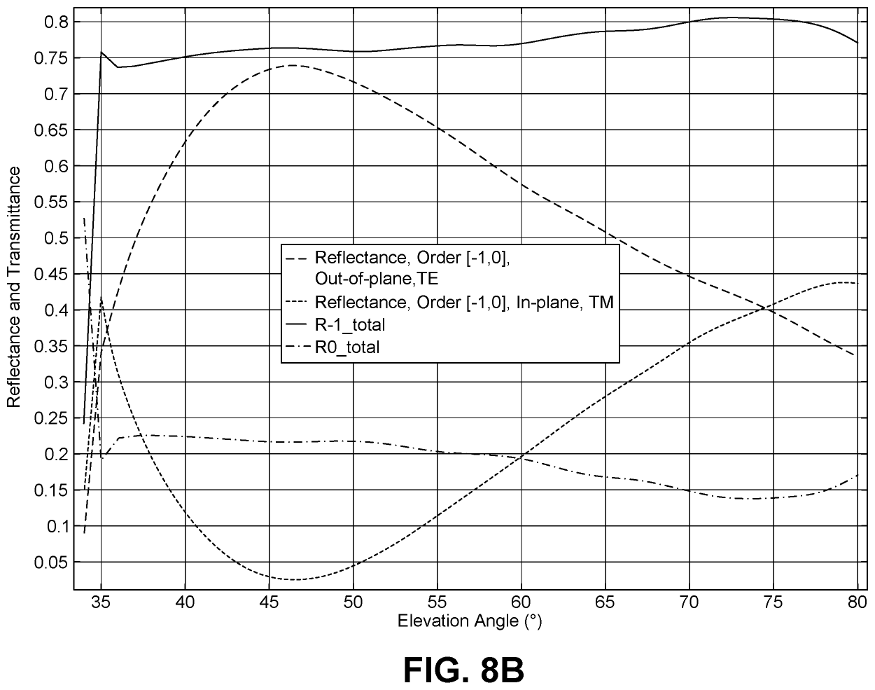

Consider an analysis of the high refractive index material reflective diffraction grating placed on the bottom of the waveguide. The general topology of the unit cell of symmetrical reflective diffraction grating is illustrated in FIG. 8A. This cross-section view may correspond to high refractive index (n₂*) element on the bottom of a homogeneous dielectric media with a refractive index n₃ (n₂*>n₃). Let us note that we can use the same material with refractive index n₂ (n₂*=n₂) to fabricate both gratings DG1 and DG2 for in-coupling system. But in general case the high index material for both gratings can be different. In some embodiments, a material other than a high index material is used for the gratings. The grating elements may be covered by a material with lower refractive index n₄ (n₂*>n₄). The full system is hosted by the homogeneous host medium with refractive index n₁. It is assumed that n₁<n₃ and n₁<n₄. W* and H* are width and height of the grating element (in general case the parameters of the grating elements for DG1 and DG2 are different W*≠W and H*≠H). H₁ is the difference between the height of the high refractive index material element and total thickness of the layer with refractive index n₄. To create the diffraction grating, we take a periodic array of the unit cells. The grating constant or the period of the grating is d=d₂. The period of diffraction grating is defined to in-couple diffraction order M₂. A linearly polarized TE plane wave is incident on the grating from the bottom in FIG. 8A).

Example embodiments use silicon (Si) as the material of the elements of the grating (n₂*=3.897+i0.021061). In some embodiments, the elements are covered by SiO₂ material (n₄=1.457). Other materials may alternatively be used.

FIG. 8A illustrates a cross-sectional view of a unit cell of high refractive index material reflective diffraction grating DG2. FIG. 8B illustrates reflectance and transmittance of reflective diffraction grating DG2 with d₂=338.38 nm, W*=50 nm, H*=150 nm, H₁=20 nm, n₁=1.0, n₂*=3.897+i0.021061, n₃=1.7663, n₄=1.457, ϕ_{G2}=π/4 vs. angle of TE polarized electromagnetic wave incidence (α) at λ=625 nm for incidence from waveguide material with refractive index n₃ and φ_{d}=π/2.

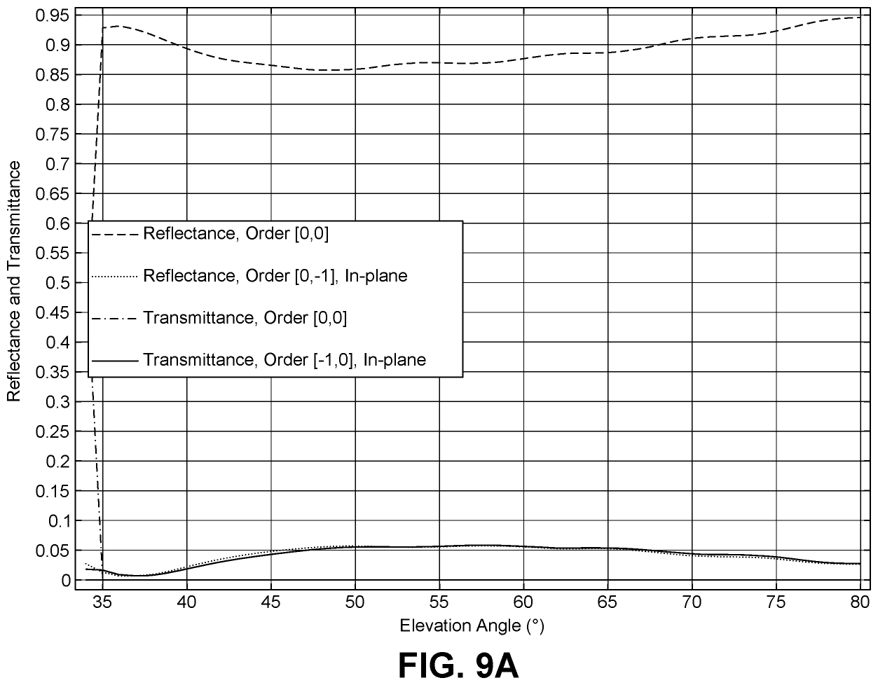

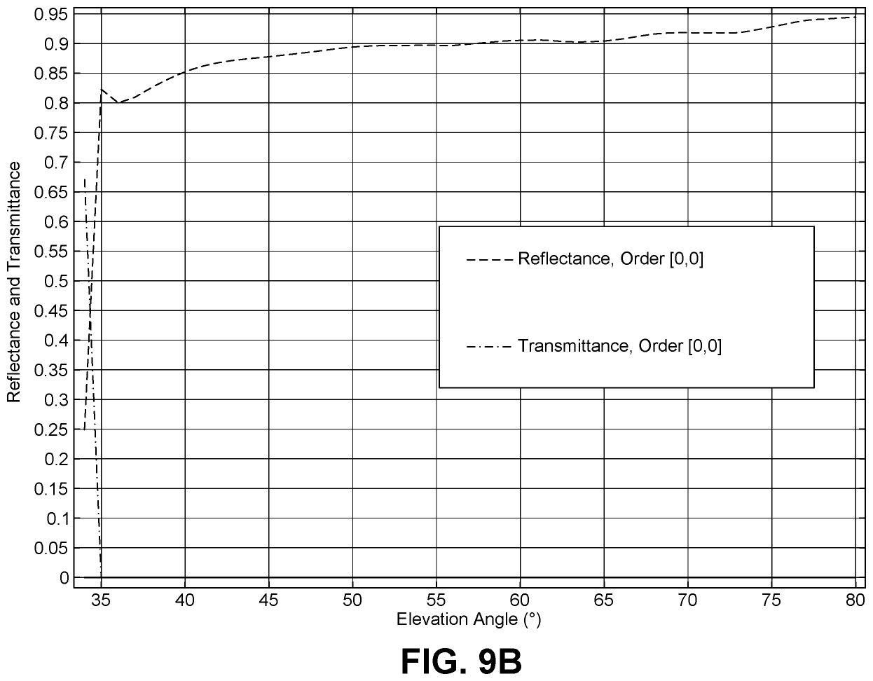

Analyzing the reflectance and transmittance of the reflective grating DG2, it can be seen that the grating with proposed parameters can effectively rotate an incident TE polarized wave. The total reflectance for rotated wave (diffracted order R[−1,0] for COMSOL simulations) may be above 75% (see curve “R−1_total” in FIG. 8B). The rotated wave will combine TE (the curve “Reflectance, order [−1,0], out-of-plane, TE”) and TM (the curve “Reflectance, order [−1,0], in-plane, TM”) polarized rays (R−1_total=R[−1,0] for TE wave (in-plane)+R[−1,0] for TM wave (out-of-plane)). About 15-20% of in-coupled efficiency will correspond to the 0 reflected order (R0_total=R[0,0] for TE wave+R[0,0] for TM wave) which will not change the direction and will be lost. To be sure that the rotated waves will be effectively reflected by the top grating DG1 we also check the reflectivity/transmittivity of TM polarized incident wave by this grating at φᵢ=−π/2 (a) and φᵢ=0 (b) (see FIG. 9A).

FIGS. 9A-9B illustrate reflectance and transmittance of TM polarized incident wave for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm at λ=625 nm vs. angle of electromagnetic wave incidence (α) for incidence from waveguide material with refractive index n₃. FIG. 9A illustrates results for azimuth angle φᵢ=−π/2. FIG. 9B illustrates results for azimuth angle φᵢ=0.

As seen in the simulation, more than 75% of in-coupled light will be rotated and finally reflected by the top grating. In example embodiments, this arrangement may be used in the case where the in-coupling grating does not have equal sizes along the Y and X axis (L≠L*, see FIG. 5). In this case the thickness of the waveguide may be decreased independently of the length of diffraction grating L, but to prevent the outcoupling of the rotated light, it is desirable for L* to be selected taking into account the possibility of the light hitting of the bottom grating a second time. For example, in the case of total possible FOV for proposed system (about 85°-90° for both modes), decreasing the thickness of the waveguide up to H_{wg}=1 mm, it may be desirable to use L*<1.37 mm to avoid the light hitting the bottom grating a second time. In this case an estimated efficiency of in-coupled light will be about 57%-60% (the uniformity of in-coupled light will be still high). To estimate the efficiency of in-coupled light, simulations can be conducted to determine the portion of light diffracted at each level, taking into account the losses and comparing it with the total input light. Decreasing the total FOV to 30° can keep the same in-coupled efficiency and thickness of the waveguide independently of the size L for L*<3 mm.

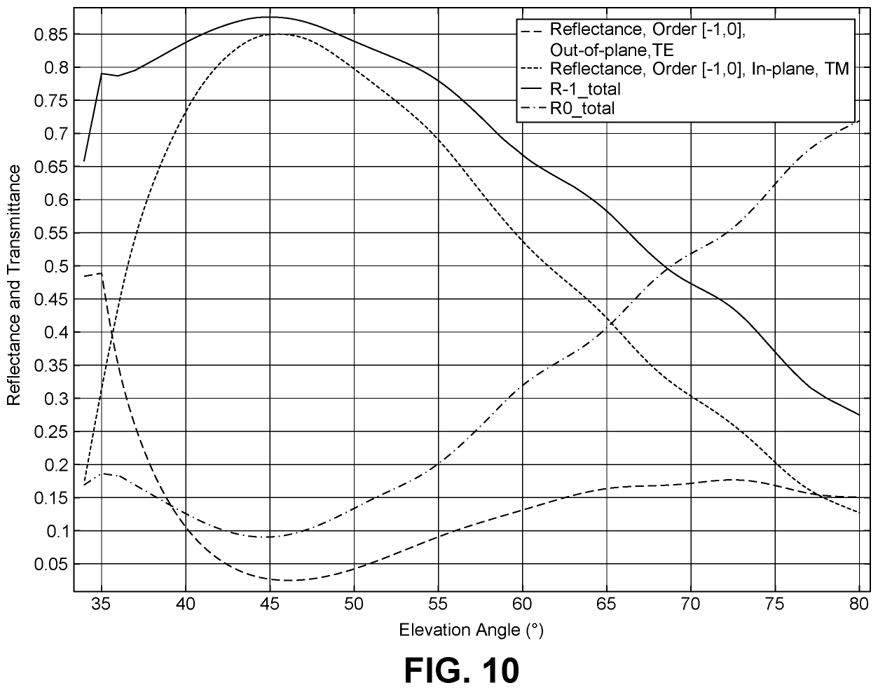

Consider the case when the rotated ray does hit the bottom grating a second time. The portion of rotated light corresponds to TE polarization which is very intensive for low angles of an incidence inside the grating and correspondingly high incident angles outside the grating. The TM polarized light portion is also not uniform and is more intense in a case of high incident angles inside the grating (this fact can be used to increase the in-coupled intensity for the system with limited lower FoV). In both cases of TE and TM polarized light rays will be split again into two diffraction orders and main portion of in-coupled light will be rotated again and finally the portion of the light corresponding to the TE mode (FIGS. 8B and 10) will be out-coupled by the top grating DG1. The portion of light corresponding to the TM mode after the new rotation will change the direction of propagation and will make an input into the in-coupled portion of light propagating along the waveguide. But about 15-20% of the in-coupled ray corresponding to the 0 reflected order for both polarizations will not be rotated and will be efficiently reflected by the top grating. So, keeping H_{wg}=1 mm and increasing the width L* up to 2.7 mm for full possible FoV (about 85°-90°) may allow efficient in-coupling of 30%-60% of an incident light (here 30% will correspond to TIR angle inside the waveguide and 60% is an efficiency of grazing rays). In the case of limited FOV equal to 30°, the same efficiency for the grating may be achieved with a width up to L*=6 mm.

FIG. 10 illustrates reflectance and transmittance of reflective diffraction grating DG2 with d₂=338.38 nm, W*=50 nm, H*=150 nm, H₁=20 nm, n₁=1.0, n₂*=3.897+i0.021061, n₃=1.7663, n₄=1.457, ϕ_{G2}=π/4 vs. angle of TM polarized electromagnetic wave incidence (α) at λ=625 nm for incidence from waveguide material with refractive index n₃ and φ_{d}=π/2.

In the case of multiple reflections (e.g. a greater width L* of the grating or thinner waveguide for the fixed width of the grating) DG2 may be configured to provide a lower portion of TE polarized rotated wave and higher portion of TM rotated wave and 40-50% efficiency for reflected 0 order. Losing about 50% of efficiency at the first step (after rotation), this allows more light to be kept inside the waveguide after multiple reflections by the top grating DG1 and due to the input of TM polarized portion of light which will not be outcoupled even after several contacts with DG2 and rotations.

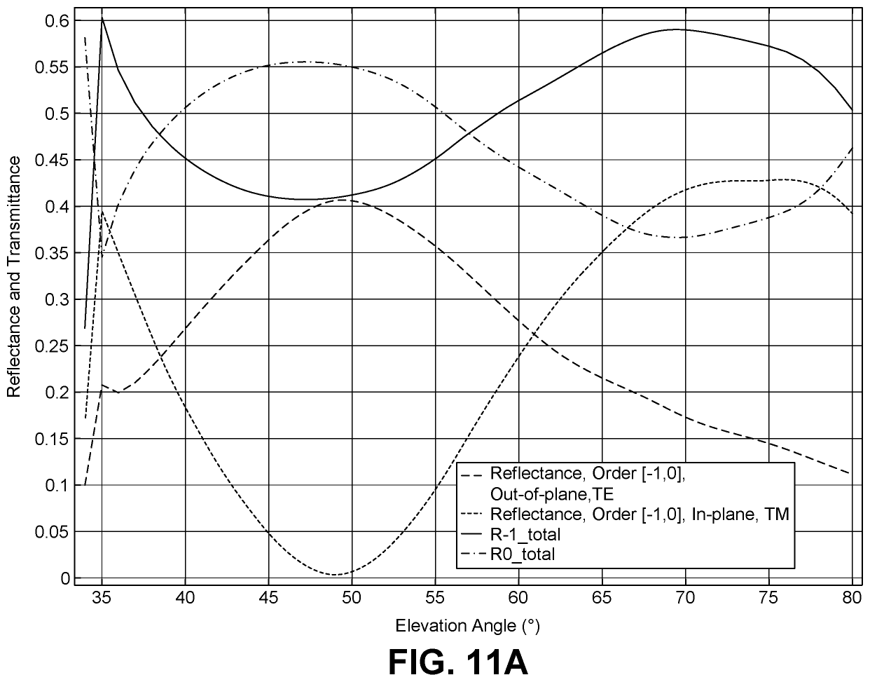

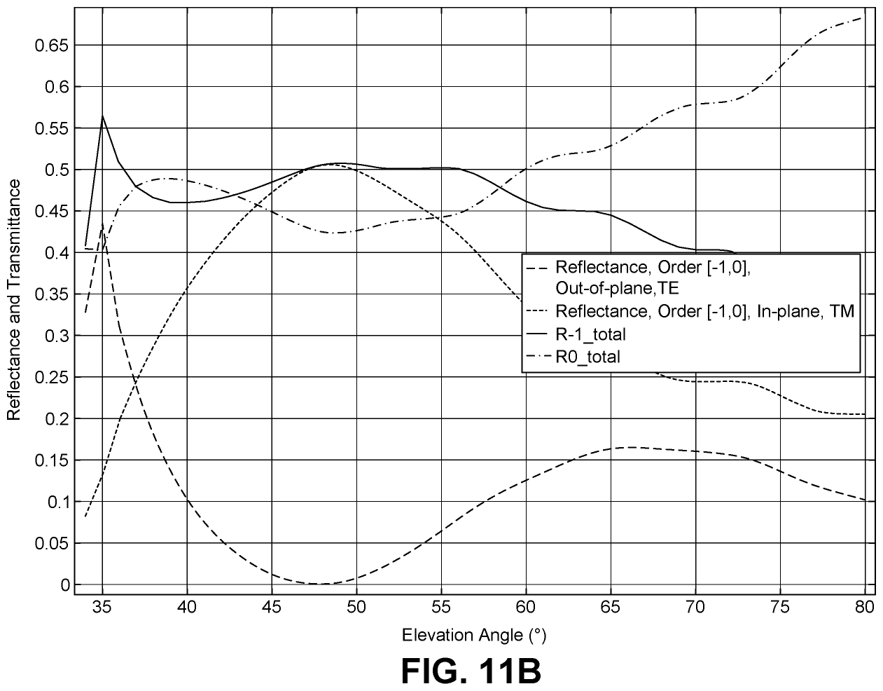

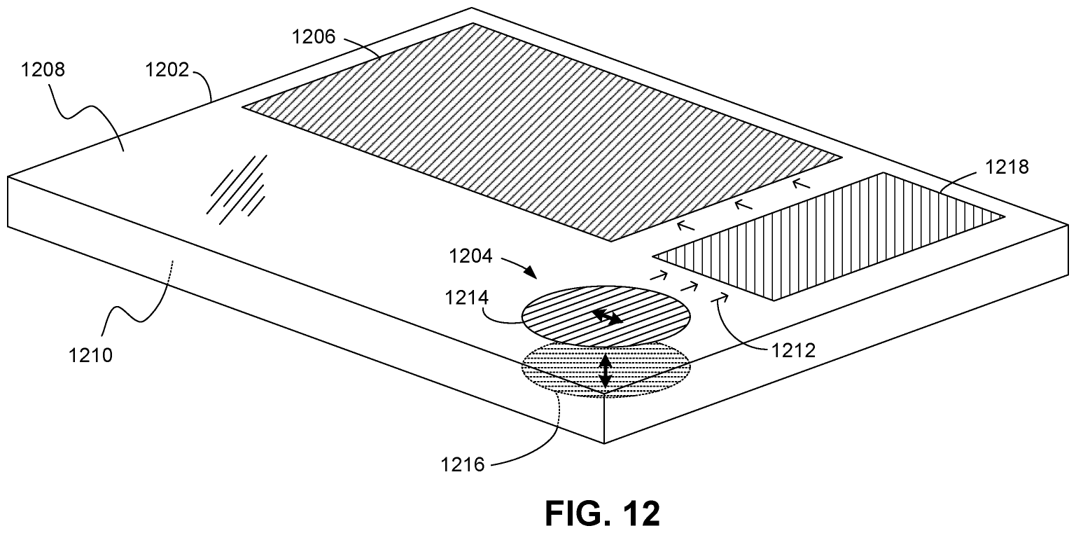

FIGS. 11A-11B illustrate reflectance and transmittance of reflective diffraction grating DG2 with d₂=338.38 nm, W*=66 nm, H*=170 nm, H₁=50 nm, n₁=1.0, n₂*=3.897+i0.021061, n₃=1.7663, n₄=1.457, ϕ_{G2}=π/4 vs. angle of TE (FIG. 11A) and TM (FIG. 11B) polarized electromagnetic wave incidence (α) at λ=625 nm for incidence from waveguide material with refractive index n₃ and φ_{d}=π/2.

Example embodiments allow for a decrease in the total thickness of the waveguide due to the rotation of the in-coupled wave inside the waveguide and partial transformation of TE polarized light into TM polarized light. Example embodiments use a double diffraction grating in-coupler for approximately 90° rotation of the in-coupled light inside the waveguide leading to the effective light trapping by the thin waveguide.

Some embodiments provide a configuration for a dual-diffraction grating in-coupler using a transmissive diffraction grating with the grating lines oriented along an optical path of the waveguide and a reflective diffraction grating with the grating lines oriented at an angle to the grating lines of the first grating.

Some embodiments provide a configuration for a reflective DG2 with polarization conversion, proper distribution between TE and TM polarized modes and uniform efficiency of the first and zeroth reflected orders. Depending on the lateral size of the first grating DG1 and thickness of the waveguide, the distribution between the efficiency of the first reflected order and zero reflected order may be configured to maximize the in-coupled efficiency and improve the uniformity.

FIG. 12 is a schematic perspective view of a waveguide display according to some embodiments. The apparatus of FIG. 12 includes a waveguide 1202 having an in-coupler 1204 and an out-coupler 1206. The waveguide has a first surface 1208 and an opposite second surface 1210, the waveguide providing an optical path (illustrated by arrows 1212) from the in-coupler to the out-coupler. In this example, there is an eye pupil expander 1218 along the optical path. The in-coupler 1204 comprises a first diffraction grating 1214 with a first grating vector on the first surface and a second diffraction grating 1216 with a second grating vector on the second surface. (The grating vectors are illustrated as double-ended arrows because their sign can be chosen arbitrarily.) At least one of the first and second grating vectors is not oriented along any of the optical paths from the in-coupler to the out-coupler (for example, having an angle of more than 10° from the optical paths). In the example of FIG. 12, the grating vector of the first diffraction grating 1214 is not oriented along the optical path 1212 to the out-coupler. In some embodiments at least one of the grating vectors is oriented at least 10° from all of the optical paths. In some embodiments at least one of the grating vectors is oriented at least 30° from all of the optical paths. In some embodiments, both of the grating vectors are oriented at least 10° from all of the optical paths. In some embodiments both of the grating vectors is oriented at least 30° from all of the optical paths.

In the specific example illustrated in FIG. 12, the waveguide 1202 is a single-mode waveguide having a single optical path 1212 to the out-coupler 1206, and the grating vector of the first diffraction grating 1214 is oriented at least 10° from the optical path. In this way, light diffracted by the first grating 1214 alone is less likely to travel along the optical path 1212 and thus less likely to create stray light that degrades the out-coupled image. Similarly, when the grating vector of the first diffraction grating 1216 is oriented at least 10° from the optical path, light diffracted by the second grating 1216 alone is less likely to travel along the optical path 1212 and thus less likely to create stray light. Conversely, light that is diffracted by both grating 1214 and 1216 travels along the optical path to generate the desired image. The same principles may be applied for use with a dual-mode waveguide having two optical paths: one or both of the grating vectors may be oriented at least 10° from all of the optical paths to reduce the effects of stray light.

In some embodiments, the first diffraction grating 1214 is a transmissive grating and the second diffraction grating 1216 is a reflective grating.

In some embodiments, the first grating vector of grating 1214 is substantially perpendicular to the optical path 1212, for example having an angle of between 80° and 100° from at least one of the optical paths.

In some embodiments, the second grating vector has an angle of 45° with respect to the first grating vector. In some embodiments, the second grating vector has an angle of between 40° and 50° with respect to the first grating vector. In some embodiments, the second grating vector has an angle of between 35° and 55° with respect to the first grating vector.

In some embodiments, the in-coupler 1204 is configured to couple incident light along the optical path 1212 using a non-zero diffractive order (e.g. the first diffractive order) of the first diffraction grating and a non-zero diffractive order (e.g. the first diffractive order) of the second diffraction grating.

In some embodiments, the second diffraction grating 1216 is metallized.

### Embodiments Using Zero-Order Diffraction by the Second Grating.

In further embodiments, an in-coupling system is provided that reduces the outcoupling of the light reflected by the backside of the waveguide by altering the polarization of in-coupled wave inside the waveguide. To change the polarization direction of the light diffracted into the waveguide by the in-coupling grating, example embodiments use a second diffraction grating oriented at an angle to the grating lines of the first grating and fabricated onto the opposite surfaces of the waveguide. To avoid the undesirable deviation of the in-coupled light by the second grating, example embodiments use a grating with a period less than the wavelength of light in the waveguide material. In contrast to the case of a single diffraction grating in-coupler example embodiments allow for reduced thickness of the waveguide while keeping quite high efficiency and uniformity of the in-coupled light. To rotate the polarization of reflected wave inside the waveguide, example embodiments use a zero-order diffraction grating with a period less than the wavelength of incident light in the waveguide material.

In example embodiments of a double-sided in-coupling geometry, two gratings (top and bottom) have different orientations. Example embodiments provide a dual diffraction grating in-coupler for rotating the polarization of the light inside the waveguide for effective coupling of an incident light into the thin waveguide. Some embodiments also provide high efficiency and high diffraction uniformity for in-coupled light in a wide angular range.

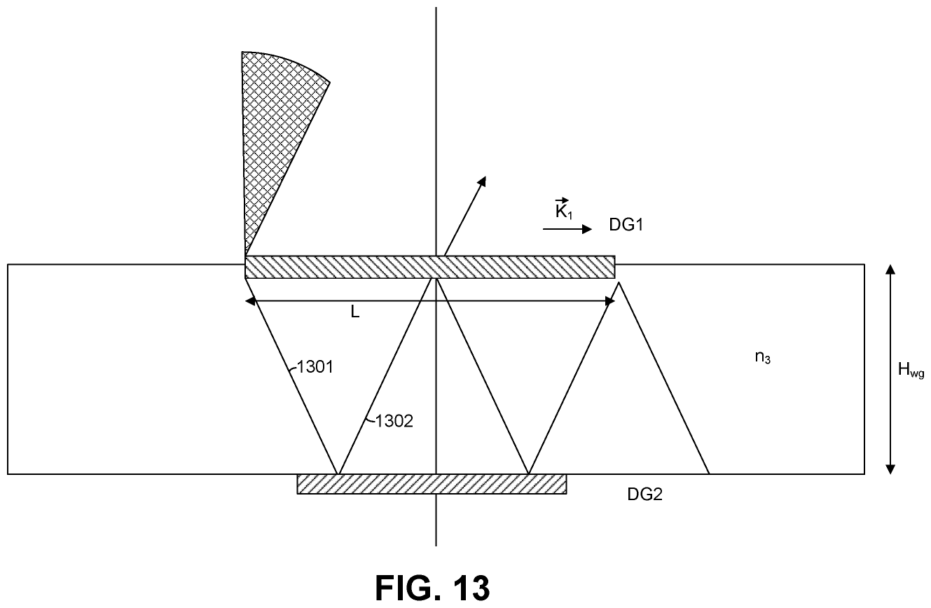

FIG. 13 is a schematic side view of a waveguide according to some embodiments illustrating in-coupled light.

An example of a double-sided in-coupler geometry with differently oriented symmetrical gratings DG1 and DG2 on both waveguide surfaces is shown in FIG. 13. H_{wg} is the thickness of the waveguide. The first transmissive diffraction grating with the grating lines oriented perpendicularly to the waveguide diffracts the incident light and in-couples it into the waveguide. The diffraction grating DG1 has lines which are perpendicular to the corresponding grating vector K₁, and vector K₁ is oriented along the waveguide (φ_{G1}=90°, φ_{K1}=π−φ_{G1}=0°); n₁ is the refractive index of the medium outside the waveguide, n₃ is the refractive index of the waveguide material, φ_{G1} is the angle of upper grating orientation. Consider one particular plane of incidence perpendicular to the grating lines of DG1. The in-coupled ray 1301 with the minimal diffracted and in-coupled angle hits the lower grating which has a different orientation. The angle of lower grating orientation is equal to φ_{G2}, correspondingly for the grating vector oriented perpendicularly to the grating lines we get φ_{K2}=π−φ_{G2}ϕₖ₂=π−ϕ_{G2}. In some embodiments, the period of the second diffraction grating DG2 is less than the wavelength in the waveguide material; as a result, only the zeroth reflected order will be diffracted by the lower grating. The incident ray 1301 will be transformed into the ray 1302. The angle at which ray 1302 will be reflected is equal to the incident angle of ray 1301. Ray 1302 corresponding to the zeroth reflected order will propagate in the same plane as an incident ray. Due to the orientation of the second grating DG2, polarization of reflected zeroth order ray may be modified, and ray 1302 will be totally or partially reflected by the upper grating DG1. Finally, the in-coupled light leaves the grating area and propagates inside the waveguide by total internal reflections (TIR).

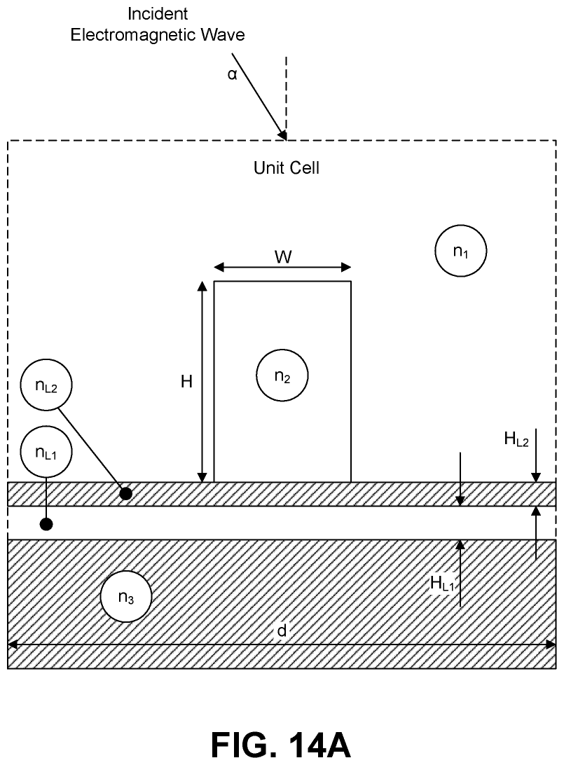

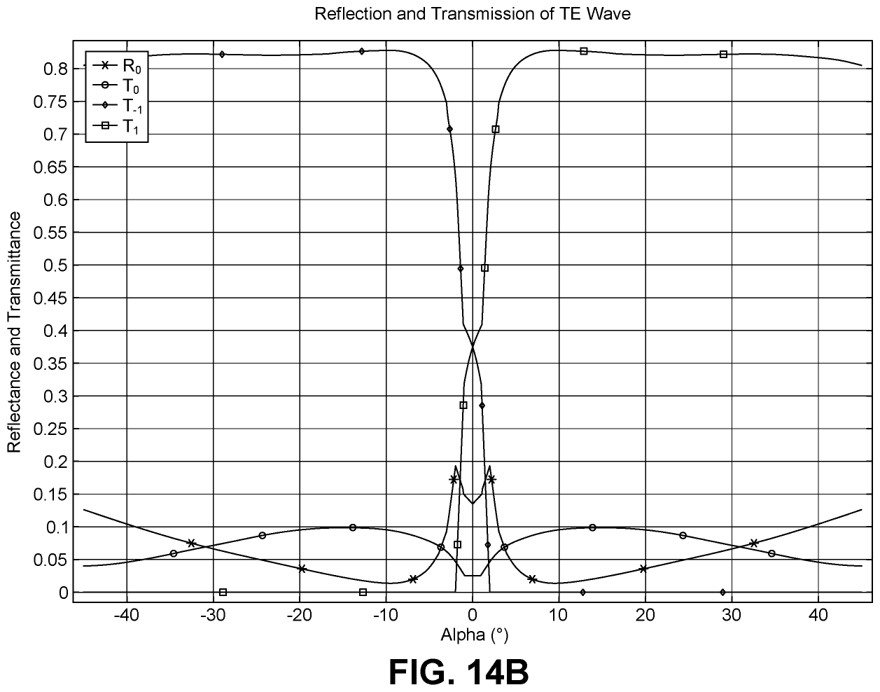

Performance of an in-coupler according to such embodiments may be evaluated with a simulation. Some embodiments use a regular high refractive index material diffraction grating DG1 with an additional thin layer (H_{L1} is the thickness of this layer with refractive index n_{L1}) placed on the top of the waveguide. The general topology of the unit cell of such a regular symmetrical transmissive diffraction grating is illustrated in FIG. 14A. This cross-section view may correspond to high refractive index (n₂) element on the top of a homogeneous dielectric media with a refractive index n₃ (n₂>n₃). The full system is hosted by the homogeneous host medium with refractive index n₁. For some embodiments, n₁<n₃. Wand H are width and height of the high refractive index element. The diffraction grating comprises a periodic array of the unit cells. The grating constant or the period of the grating is d=d₁. The period of diffraction grating is selected to in-couple diffraction order M₁. To select the grating pitch, an assumption may be made that the biggest angular span that can be coupled propagates into the waveguide by TIR. A linearly polarized TE plane wave is incident on the grating from the top in a plane perpendicular to the grating. To simplify the fabrication process, some embodiments include a stop layer between this thin layer and elements of the grating. n_{L2} is the stop layer material refractive index and H_{L2} is the thickness of this layer. Silicon (Si) may used as the material of the elements of the gratings (n₂=3.897+i0.021061), or another material may be used. The presented data were obtained using the COMSOL Multiphysics software.

FIG. 14A is a cross-sectional view of a unit cell of high refractive index material regular in-coupling diffraction grating DG1 that may be used in some embodiments. Other cross-sectional configurations may be used in other embodiments.

FIG. 14B is a graph illustrating reflectance and transmittance of a TE polarized incident wave for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm vs. angle of electromagnetic wave incidence (α) at λ=625 nm for incidence from host medium with refractive index n₁.

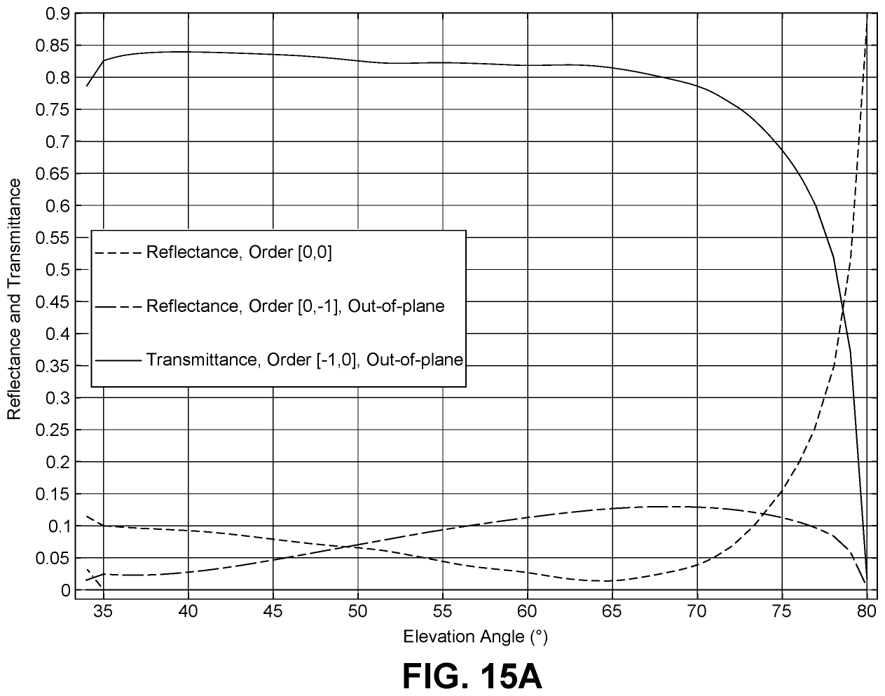

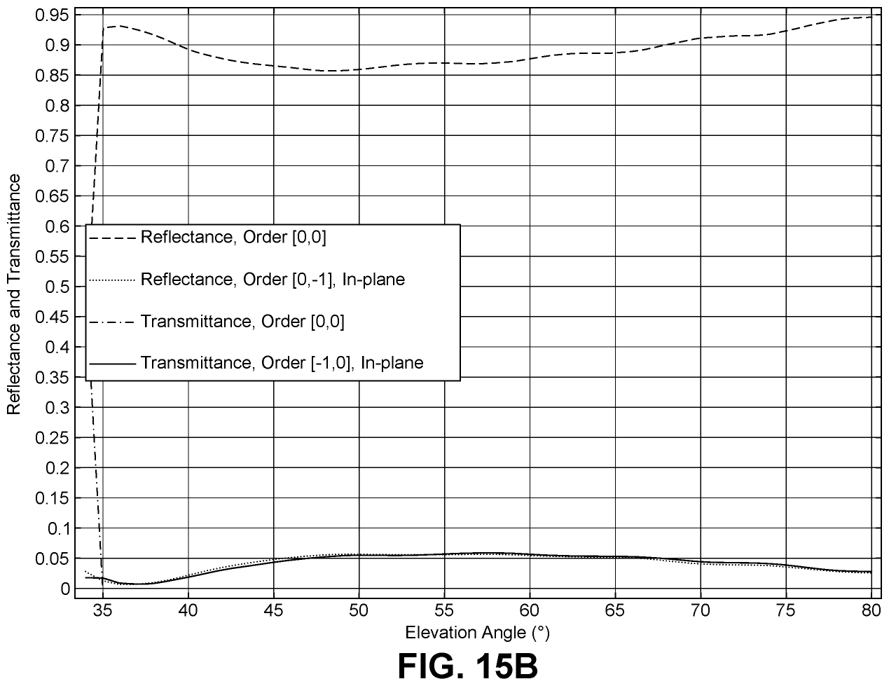

The computed reflectance and transmittance for TE incidence for such regular grating oriented perpendicularly to the waveguide (φ_{G1}=90°, φ_{K1}=π−φ_{G1}=0°) vs. incident angle α is plotted in FIG. 14B. It illustrates the reflectance for 0-order and transmittance for 0 and ±1 orders. It can be seen that such high refractive index material diffraction grating has a high intensity for transmitted first order with maximal intensity equal to hₘₐₓ=82.76%. The diffraction uniformity is equal to 94.83%. The diffraction power of such grating is equal to 81.75%. But in the case of a thin waveguide the in-coupled light is reflected back from the backside of the waveguide onto the grating area. It will hit the in-coupling grating DG1, and much of the light will be out-coupled, leading to the reduction of the portion of in-coupled light. To demonstrate this, the computed reflectance and transmittance are analyzed for TE incidence from the waveguide material with refractive index n₃ (see the curve “Transmittance, order [−1,0], out-of-plane” in FIG. 15A).

FIGS. 15A-15B illustrate reflectance and transmittance of TE (FIG. 15A) and TM (FIG. 15B) polarized incident waves for regular shape transmissive diffraction grating DG1 with d₁=358 nm, W=80 nm, H=110 nm, n₁=1.0, n₂=3.897+i0.021061, n₃=n_{L2}=1.7663, n_{L1}=2.5884, H_{L1}=H_{L2}=10 nm at λ=625 nm vs. angle of electromagnetic wave incidence (α) for incidence from waveguide material with refractive index n₃.

For comparison the computed reflectance and transmittance are also presented for TM incidence from the waveguide material with refractive index n₃ (FIG. 15B). The TM-polarized incident wave will be almost totally reflected by the grating DG1. So, the polarization rotation of the in-coupled light can help prevent the consequent out-coupling of the light after interaction with the grating DG1.

To rotate the polarization of an in-coupled light, example embodiments use a second lower grating DG2 with grating orientation angle equal to φ_{G2}.

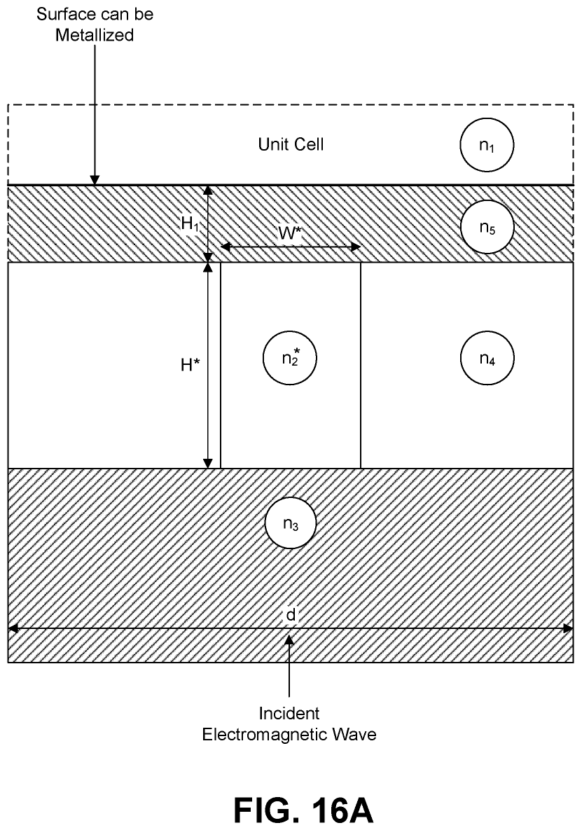

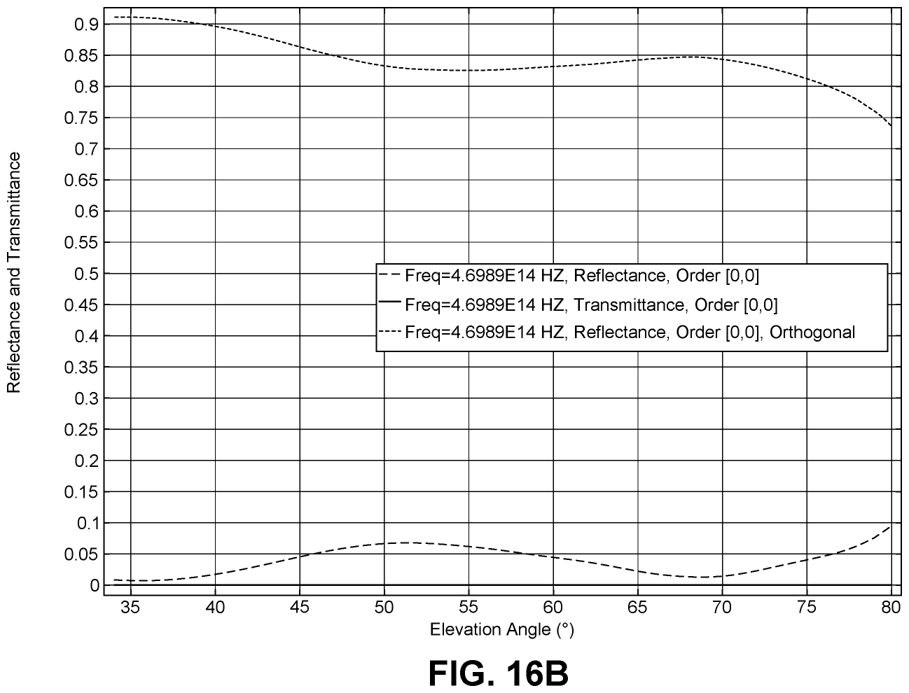

The extent of polarization rotation is affected by the orientation of DG2 and the parameters of the grating. Consider an embodiment with a high refractive index material reflective diffraction grating placed on the bottom of the waveguide. The general topology of the unit cell of symmetrical reflective diffraction grating is illustrated in FIG. 16A. This cross-section view may correspond to high refractive index (n₂*) element on the bottom of a homogeneous dielectric medium with a refractive index n₃ (n₂*>n₃). The same material with refractive index n₂ (n₂*=n₂) may be used to fabricate both gratings DG1 and DG2 for in-coupling system. But in general case the material for both gratings can be different, and some embodiments do not use a high refractive index material. The grating element may be covered by a material with lower refractive index n₄ (n₂*>n₄). The full system may be hosted by a homogeneous host medium with refractive index n₁. In example embodiments, n₁<n₃ and n₁<n₄. W* and H* are width and height of the high refractive index element (in general case the parameters of the high index elements for DG1 and DG2 are different W*≠W and H*≠H, though they may be equal in some embodiments). H₁ is the thickness of the layer with refractive index n₅. The diffraction grating comprises a periodic array of the unit cells. The grating constant or the period of the grating is d=d₂. The period of diffraction grating is selected to diffract only the zeroth diffractive order. A linearly polarized TE plane wave is incident on the grating form the waveguide material from the bottom in FIG. 16A.

Example embodiments use silicon as the material of the elements of the grating (n₂*=3.897+i0.021061). The elements may be covered by SiO₂ material (n₄=n₅=1.457) and the top of the grating may be metallized. Different grating materials may be used in different embodiments.

FIG. 16A is a cross-sectional view of a unit cell of high refractive index material reflective diffraction grating DG2.

FIG. 16B is a graph illustrating reflectance and transmittance of reflective diffraction grating DG2 with d₂=150 nm, W*=80 nm, H*=140 nm, H=80 nm, n₁=1.0, n₂*=3.897+i0.021061, n₃=1.7663, n₄=n₅=1.457, φ_{G2}=45° vs. angle of TE polarized electromagnetic wave incidence (α) at λ=625 nm for incidence from waveguide material with refractive index n₃. The surface between materials with refractive indexes n₁ and n₅ was metallized.

Analyzing the reflectance and transmittance of the reflective grating DG2, it can be concluded that example gratings as described herein can effectively change polarization of an incident TE polarized wave. For the dependence presented in FIG. 16B the reflectance of 0 order for a wave with orthogonal polarization (TM polarized wave) in the angular range from TIR angle to grazing angle (75°) will be above 80% (see curve “Reflectance, order [0,0], orthogonal” in FIG. 16B).

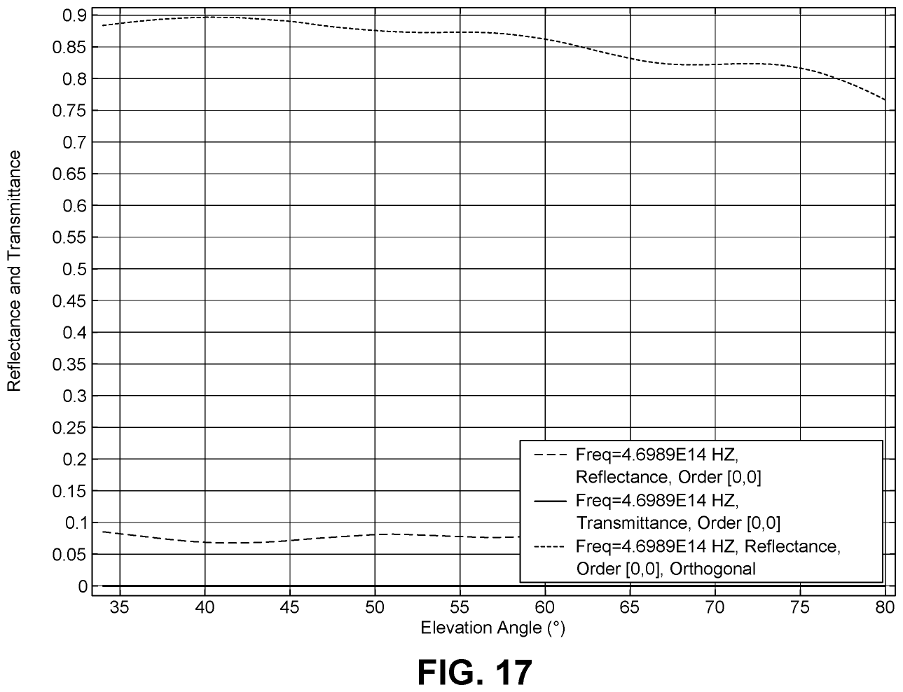

Some embodiments use alternative topologies for DG2. For example, the metallic film may be placed at some distance from the top of the grating (e.g. in a case where n₅=1). In this case the grating may demonstrate even higher efficiency (see FIG. 17).

FIG. 17 is a graph illustrating reflectance and transmittance of reflective diffraction grating DG2 with d₂=150 nm, W*=35 nm, H*=185 nm, H₁=5 nm, n₁=n₅=1.0, n₂*=3.897+i0.021061, n₃=1.7663, n₄=1.457, φ_{G2}=45° vs. angle of TE polarized electromagnetic wave incidence (α) at λ=625 nm for incidence from waveguide material with refractive index n₃. The surface between materials with refractive indexes n₁ and n₅ was metallized.

Combining two gratings as described above, for the diffraction grating length L=5 mm and limited FoV of the system equal to 30°, and in the case of laser source illumination for H_{wg} between 0.85 and 0.9 mm, the in-coupled intensity of the rays propagating at minimal angle inside the waveguide may be approximately equal to 55%. This case corresponds to the single hitting of the top grating. Decreasing the waveguide thickness up H_{wg} between 0.57 and 0.6 (double hitting of the top grating) we can get about 3-3.5%.

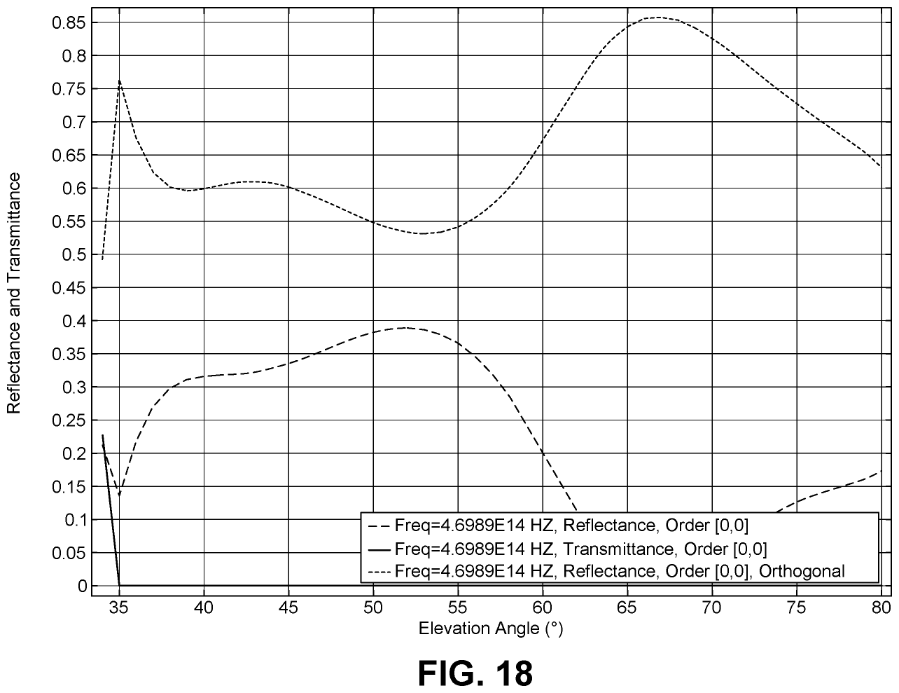

Some embodiments, e.g. those with a reduced FoV, can be implemented without the metallic layer on the top of the grating making the system transparent. For a nonmetallized case, the bottom grating may additionally be rotated. An example embodiment using a nonmetallized grating is presented in FIG. 18. Such an embodiment demonstrates high effectiveness (above 60%) for angular range 57°-75° inside the waveguide, with an angular range covering FoV=30°.

FIG. 18 is a graph illustrating reflectance and transmittance of nonmetallized reflective diffraction grating DG2 with d₂=130 nm, W*=40 nm, H*=270 nm, H=180 nm, n₁=1.0, n₂*=3.897+i0.021061, n₃=1.7663, n₄=n₅=1.457, φ_{G2}=60° vs. angle of TE polarized electromagnetic wave incidence (α) at λ=625 nm for incidence from waveguide material with refractive index n₃.

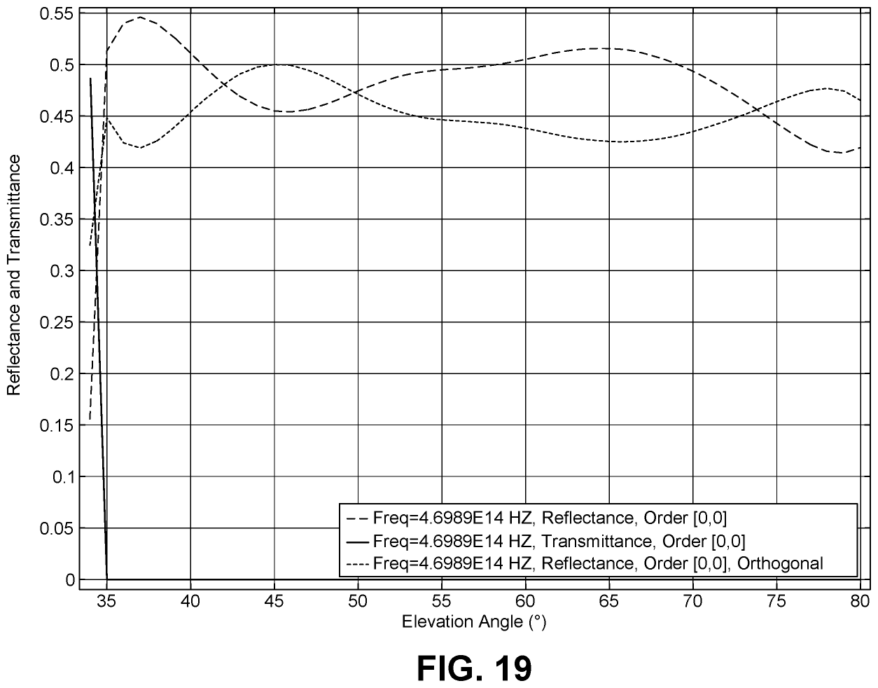

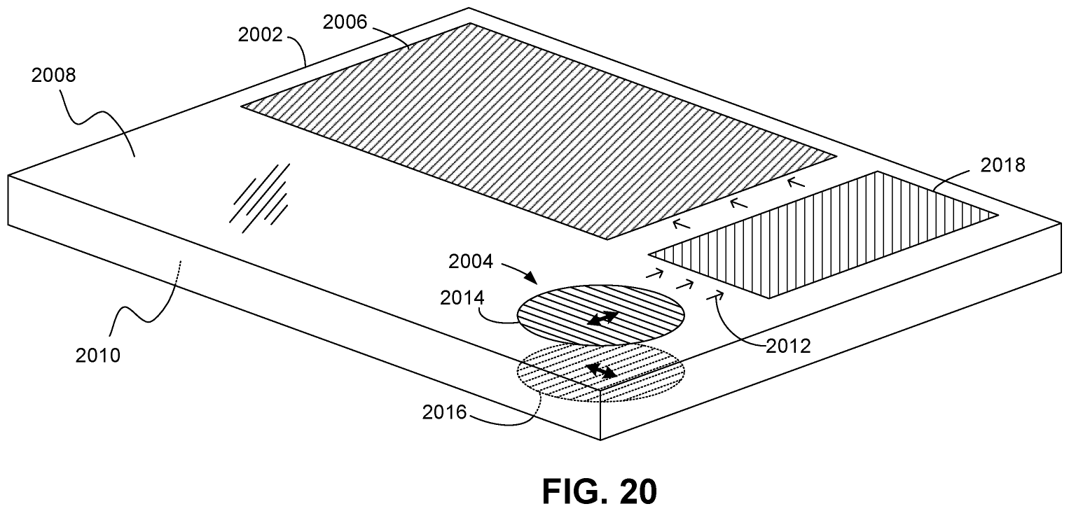

In the case of multiple reflections, (case of bigger width L of the grating or thinner waveguide for the fixed width of the grating) different parameters may be selected for DG2 providing lower efficiency of polarization transformation. For example, transforming just a half of incident TE polarized light into TM polarized (see FIG. 19) we will get lower efficiency of the in-coupled light for single hitting of the top grating, but for the double hitting case it will be higher. Combining in-coupling grating with the DG2 with performance presented in FIG. 19, for the diffraction grating length L=5 mm and limited FoV of the system equal to 30°, we can get that in the case of laser source illumination for H_{wg} between 0.85 and 0.9 mm the in-coupled intensity of the rays propagating at minimal angle inside the waveguide will be approximately equal to 32% (single hitting of the top grating). Decreasing the waveguide thickness up to H_{wg} between 0.57 and 0.6 (double hitting of the top grating) we can get about 12%.

FIG. 19 illustrates reflectance and transmittance of nonmetallized reflective diffraction grating DG2 with d₂=130 nm, W*=40 nm, H*=250 nm, H=140 nm, n₁=1.0, n₂*=3.897+i0.021061, n₃=1.7663, n₄=n₅=1.457, φ_{G2}=75° vs. angle of TE polarized electromagnetic wave incidence (α) at λ=625 nm for incidence from waveguide material with refractive index n₃.

Example embodiments allow for a decrease of the total thickness of the waveguide due to the polarization transformation for the in-coupled wave without light deviation inside the waveguide. Example embodiments use a double diffraction grating in-coupler solution. For the double-sided in-coupling geometry, two gratings (top and bottom) may be oriented differently.

Some embodiments provide a dual diffraction grating in-coupler in which a transmissive diffraction grating has grating lines oriented perpendicularly to the waveguide and a reflective diffraction grating has grating lines oriented at an angle to the grating lines of the first grating and pitch and parameters configured to improve the diffraction efficiency of the zero reflected order for orthogonal polarization. In some embodiments the bottom grating converts the polarization of more than 50% of the incident light.

Some embodiments provide configurations of reflective DG2 with polarization conversion for zeroth reflected orders. Depending on the lateral size of the first grating DG1 and thickness of the waveguide, the polarization transformation efficiency can be selected based on desired in-coupled efficiency and uniformity.

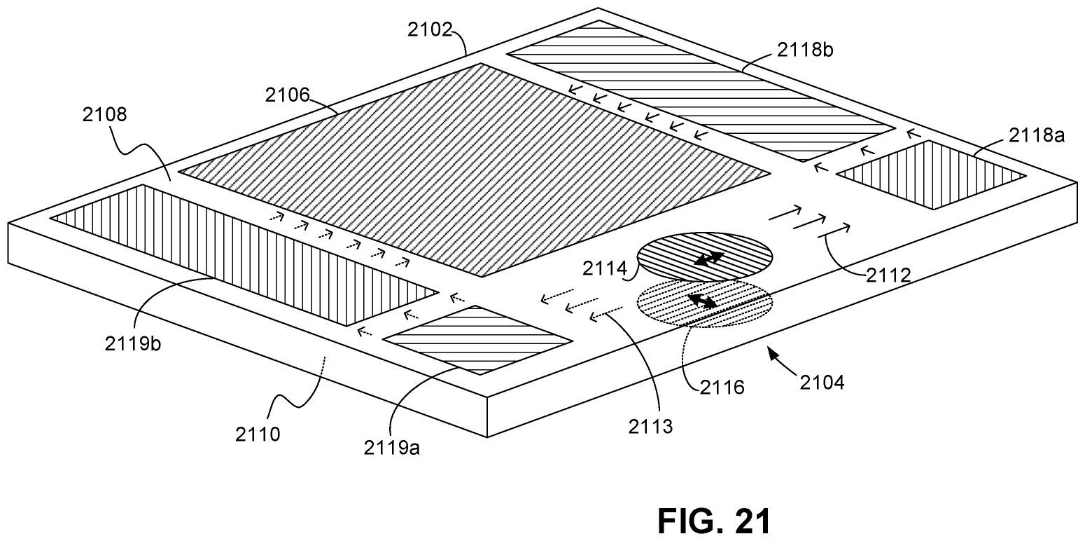

FIG. 20 is a schematic perspective view of a waveguide display according to some embodiments. The apparatus of FIG. 20 includes a waveguide 2002 having an in-coupler 2004 and an out-coupler 2006. The waveguide has a first surface 2008 and an opposite second surface 2010, the waveguide providing an optical path (illustrated by arrows 2012) from the in-coupler to the out-coupler. In this example, there is an eye pupil expander 2018 along the optical path. The in-coupler 2004 comprises a first diffraction grating 2014 with a first grating vector on the first surface and a second diffraction grating 2016 with a second grating vector on the second surface. (The grating vectors are illustrated as double-ended arrows because their sign can be chosen arbitrarily.) At least one of the first and second grating vectors is not oriented along any of the optical paths from the in-coupler to the out-coupler. In the example of FIG. 20, the grating vector of the second diffraction grating 2016 is not oriented along the optical path 2012 to the out-coupler. In some embodiments at least one of the grating vectors is oriented at least 10° from the optical path. In some embodiments at least one of the grating vectors is oriented at least 20° from the optical path. In some embodiments at least one of the grating vectors is oriented at least 30° from the optical path.

In the specific example of FIG. 20, the second grating vector is oriented at least 10° from the optical path. In this way, light that is diffracted only by the second grating 2016 (e.g. after having been transmitted through the zeroth order of the first grating 2014) is less likely to be directed along the optical path 2012 and to generate stray light that degrades the desired image.

In some embodiments, the first diffraction grating 2014 is a transmissive grating and the second diffraction grating 2016 is a reflective grating.

In some embodiments, the second grating vector has an angle of between 45° and 90° from the first grating vector.

The diffraction grating elements may optionally be made of a high refractive index material such as silicon.

In some embodiments, the in-coupler is configured to couple incident light along at least one of the optical paths using a non-zero diffractive order (e.g. a first diffractive order) of the first diffraction grating and the zeroth diffractive order of the second diffraction grating.

In some embodiments, the second diffraction grating has a grating period shorter than a wavelength of incident light in the waveguide. In some embodiments, the second diffraction grating has a grating period less than 300 nm. In some embodiments, the second diffraction grating has a grating period less than 200 nm. In general, the wavelengths that of light that can be diffracted to a non-zero diffractive order are limited by the grating period. In theory, the maximum wavelength of normally-incident light that a grating can diffract to a non-zero diffractive order is equal to twice the grating period, and in practice, the diffractive efficiency drops even before this limit is reached. Thus, diffraction gratings with a period shorter than that of incident light (e.g. visible light) tend to transmit and/or reflect light to the zeroth diffractive order, leading to a rotation of the polarization without a substantial amount of stray light that might otherwise be generated by diffraction to non-zero orders.

In some embodiments, the second diffraction grating is metallized. In some embodiments, the second diffraction grating has a grating period less than 200 nm. In some embodiments, for a waveguide has a refractive index 1.7663 and is configured for use with incident light having a wavelength of 625 nm. In some embodiments, for a waveguide having refractive index n₃ configured to guide light of wavelength λ, the second diffraction grating has a grating period below λ/n₃.

FIG. 21 is a schematic perspective view of a waveguide display according to some embodiments. The apparatus of FIG. 21 includes a waveguide 2102 having an in-coupler 2104 and an out-coupler 2106. The waveguide has a first surface 2108 and an opposite second surface 2110, the waveguide in this example providing two optical paths from the in-coupler to the out-coupler, one path illustrated by solid arrows 2112 and another path illustrated by dashed arrows 2113. In this example, there are two eye pupil expanders along each optical path: eye pupil expanders 2118a and 2118b along path 2112, and eye pupil expanders 2119a and 2119b along path 2113.

The in-coupler 2104 comprises a first diffraction grating 2114 with a first grating vector on the first surface and a second diffraction grating 2116 with a second grating vector on the second surface. (The grating vectors are illustrated as double-ended arrows because their sign can be chosen arbitrarily.) At least one of the first and second grating vectors is not oriented along any of the optical paths from the in-coupler to the out-coupler. In the example of FIG. 21, the grating vector of the second diffraction grating 2116 is not oriented along either the optical path 2112 or the optical path 2113 to the out-coupler. In some embodiments at least one of the grating vectors is oriented at least 10° from all of the optical paths. In some embodiments at least one of the grating vectors is oriented at least 30° from all of the optical paths.

In the specific example of FIG. 20, the second grating vector is oriented at least 10° from either one of the two optical paths. In this way, light that is diffracted only by the second grating 2116 (e.g. after having been transmitted through the zeroth order of the first grating 2114) is less likely to be directed along either of the optical paths 2112 or 2113 and to generate stray light that degrades the desired image.

In some embodiments, the first diffraction grating 2114 is a transmissive grating and the second diffraction grating 2016 is a reflective grating.

In some embodiments, the second grating vector has an angle of between 45° and 90° from the first grating vector.

In some embodiments, the in-coupler is configured to couple incident light along one or both of the optical paths 2112, 2113 using a non-zero diffractive order of the first diffraction grating. For example, incident light may be coupled along path 2112 using the first diffractive order of the first diffraction grating, and incident light may be coupled along path 2113 using the negative-first diffractive order of the first diffraction grating. Different portions of an in-coupled field-of-view may be coupled along different paths to increase the field of view. After being diffracted into the waveguide by the first diffraction grating, light may then be diffracted with the zeroth diffractive order of the second diffraction grating, which may alter the polarization state of the light. As a result of the altered polarization state, any light reflected from the second diffraction grating 2116 is less likely to be out-coupled if it strikes the first diffraction grating 2114 a second time.

In some embodiments, the second diffraction grating has a grating period shorter than a wavelength of incident light in the waveguide. In some embodiments, the second diffraction grating has a grating period less than 300 nm. In some embodiments, the second diffraction grating has a grating period less than 200 nm. In some embodiments, the second diffraction grating is metallized. In some embodiments, the second diffraction grating has a grating period less than 200 nm. In some embodiments, for a waveguide has a refractive index 1.7663 and is configured for use with incident light having a wavelength of 625 nm. In some embodiments, for a waveguide having refractive index n₃ configured to guide light of wavelength λ, the second diffraction grating has a grating period below λ/n₃.

Although features and elements are described above in particular combinations, one of ordinary skill in the art will appreciate that each feature or element can be used alone or in any combination with the other features and elements.

1. An apparatus comprising:
a waveguide having an in-coupler and an out-coupler, the waveguide having a first surface and an opposite second surface, the waveguide providing at least one optical path from the in-coupler to the out-coupler;
wherein the in-coupler comprises a first diffraction grating with a first grating vector on the first surface and a second diffraction grating with a second grating vector on the second surface, and wherein at least one of the first and second grating vectors is not oriented along any of the optical paths from the in-coupler to the out-coupler.

2. The apparatus of claim 1, wherein the first grating vector has an angle of between 80° and 100° from at least one of the optical paths.

3. The apparatus of claim 1, wherein the second grating vector has an angle of between 35° and 55° with respect to the first grating vector.

4. The apparatus of claim 1, wherein the in-coupler is configured to couple incident light along at least one of the optical paths using a non-zero diffractive order of the first diffraction grating and a non-zero diffractive order of the second diffraction grating.

5. The apparatus of claim 1, wherein the first grating vector has an angle within 10° of at least one of the optical paths.

6. The apparatus of claim 1, wherein the second grating vector has an angle between 45° and 90° with respect to the first grating vector.

7. The apparatus of claim 1, wherein the in-coupler is configured to couple incident light along at least one of the optical paths using a non-zero diffractive order of the first diffraction grating and the zeroth diffractive order of the second diffraction grating.

8. The apparatus of claim 1, wherein the second diffraction grating has a grating period shorter than a wavelength of incident light in the waveguide.

9. The apparatus of claim 1, wherein the second diffraction grating has a grating period less than 300 nm.

10. The apparatus of claim 1, wherein at least one of the gratings comprises silicon grating elements.

11. An apparatus comprising:
a waveguide having an in-coupler and an out-coupler, the waveguide having a first surface and an opposite second surface, the waveguide providing at least one optical path from the in-coupler to the out-coupler;
wherein the in-coupler comprises a first diffraction grating with a first grating vector on the first surface and a second diffraction grating with a second grating vector on the second surface, the second diffraction grating having a grating period less than 300 nm.

12. The apparatus of claim 11, wherein the second grating vector has an angle of at least 350 with respect to the first grating vector.

13. A method comprising:
directing incident light on an in-coupler of a waveguide, the in-coupler comprising a first diffraction grating with a first grating vector on a first surface of the waveguide and a second diffraction grating with a second grating vector on an opposite second surface of the waveguide, the waveguide providing at least one optical path from the in-coupler to an out-coupler of the waveguide, wherein at least one of the first and second grating vectors is not oriented along any of the optical paths from the in-coupler to the out-coupler; and
diffracting the incident light to a non-zero diffractive order with the first diffraction grating; and
reflecting the diffracted light with the second diffraction grating.

14. The method of claim 13, wherein the in-coupler is configured to couple incident light along at least one of the optical paths using a non-zero diffractive order of the first diffraction grating and a non-zero diffractive order of the second diffraction grating.

15. The method claim 13, wherein the in-coupler is configured to couple incident light along at least one of the optical paths using a non-zero diffractive order of the first diffraction grating and the zeroth diffractive order of the second diffraction grating.

16. The method of claim 13, wherein the second diffraction grating has a grating period shorter than a wavelength of the incident light in the waveguide.

17. An apparatus comprising:
an image generator configured to generate incident light representing an image;
a waveguide having a first surface and an opposite second surface;
a transmissive diffraction grating on the first surface configured to diffract the incident light into the waveguide; and
a reflective diffraction grating on the second surface configured to rotate the polarization of the incident light.

18. The apparatus of claim 17, wherein the reflective diffraction grating has a grating period shorter than a wavelength of the incident light in the waveguide.

19. The apparatus of claim 17, wherein the waveguide includes an out-coupler, and wherein the transmissive diffraction grating and the reflective diffraction grating are configured to couple incident light along an optical path to the out-coupler using a non-zero diffractive order of the first diffraction grating and the zeroth diffractive order of the second diffraction grating.

20. The apparatus of claim 17, wherein the waveguide includes an out-coupler, wherein the transmissive diffraction grating and the reflective diffraction grating are configured to couple incident light along an optical path to the out-coupler using a non-zero diffractive order of the first diffraction grating and a non-zero diffractive order of the second diffraction grating.
